(19) United States
(12) Patent Application Publication
(10) Pub. No.: US 2025/0284935 A1
(43) Pub. Date: Sep. 11, 2025

(54) Learning Machines that Are Free from Post-Selections

(71) Applicant: Juyang Weng, Okemos, MI (US)

(72) Inventor: Juyang Weng, Okemos, MI (US)

(21) Appl. No.: 17/737,817

(22) Filed: May 5, 2022

(51) Int. Cl. G06N 3/047; G06N 3/049

(52) U.S. Cl. CPC G06N 3/047; G06N 3/049

(57) ABSTRACT

An analogy of Post-Selections is: “Somebody claims that his scheme provided a lottery ticket number that has won $1M, but he conceals that the scheme has spent 2 millions of lottery tickets of $1 each. The reported ticket is only the luckiest. The luckiest ticket was Post-Selected after the actual lottery test. The luckiest lottery ticket will not have the same luck next time.” Many machine learning methods suffer from Post-Selections, from neural networks, to reservoir computation, to swam intelligence to evolutionary computation. The numbers $1M, 2M and $1 and the chance to win in the analogy differ across different machine learning problems, but the nature of the flaw in the reports is basically the same. This invention presents a method that does not need any Post-Selections since it trains only one network that is computed in a closed form that corresponds to the most-probable network from training experience.

### BACKGROUND OF THE INVENTION

AI research dates back at least to early 1910 when Leonardo Torres y Quevedo built a chess end game player called EI Ajedrecista [1]. In 1950, Alan Turing published his now celebrated paper [2] titled Computing Machinery and Intelligence. Turing [2] was impressive to have discussed a wide variety of considerations for machine intelligence, as many as nine categories. Unfortunately, he suggested to consider what is now called the Turing Test that has inspired and misled many AI researchers.

Much progress has been made in AI since then and many methods have been developed to deal with AI problems. As the scope of this paper, we will focus on generalization.

Traditional AI methods fall into two broad schools [3], symbolic and connectionist, although many published methods are a mixture of both.

Intuitively speaking, Post-Selections mean first casting a dice for each of multiple trained systems and then pick a system based on their performances. The Post-Selections are rooted in symbols and handcrafted representations in the symbolic school, symbols and rigid architectures in the connectionist school. The developmental school, motivated by brain development across a lifetime, avoids the Post-Selections since every life must successfully develop and must not be dropped by Post-Selections. Therefore, let us first discuss the three AI schools.

### A. Symbolic School

Symbols are used in many AI methods (e.g., states in HMMs Hidden Markov Models), nodes in Graphical Models and attributes in SLAM (Simultaneous Localization And Mapping). Although symbols are intuitive to a human programmer since he defines the associated meanings, symbols are static and have some fundamental limitations that have not received sufficient attention.

The symbolic school [4] assumes a micro-world in 4D space-time in which a set of objects or concepts, e.g., L={l₁, l₂, . . . , lₙ}, is assumed to be uniquely defined among many human programmers and their computers, represented by a series of symbols in time {l₁(t), l₂(t), . . . lₙ(t)|t₀≤t<t₁}. The correspondences among all these symbols {lᵢ} of the same object across different times are known as “the frame problem” [4] in AI which means that the programmer must manually link every symbol along time with its corresponding physical object. In computer vision, the symbolic school assumes a single symbol oᵢ, for all its 3D positions in its 3D trajectory {x(t)|t₀≤t≤t₁} and uses certain techniques, such as feature tracking through video (e.g., for driverless cars). Therefore, the symbolic school is based on human-handcrafted set of symbols and their assumed meanings. Marvin Minsky wrote that symbols are “neat” [5], but in fact, symbols are “neat” mainly in a single human programmer's understanding but not between different programmers and not in relating computer programs to a real world.

We will see the Developmental Network (DN) model of a brain is free from any symbols in its full version. Abstract symbols correspond to action/state vectors in the motor area of DN. Therefore, the frame problem is automatically solved through emergent action/state vectors in a physically grounded DN, without using any symbols in the DN's internal representations.

A major problem for symbolic AI is the generalization issue of symbols as defined here.

Definition 1 (Brittleness of static symbols): Suppose a symbolic AI machine M(L) designed for a handcrafted set L of symbols is applied to a real world that requires a new set of symbols L′, with L∩L′≠∅, M(L) fails without a human programmer who handcrafts an appropriate mapping function ƒ: L′ [symbol] L that maps every element of L′ to an element in L so that M(ƒ(L′)) works correctly as before.

Many expert systems (e.g., CYC, WordNet and EDR [6]) and “big data” projects [7] require a human programmer to be in the loop of handcrafting such a mapping ƒ during deployment. For example, an machine M developed in Florida is deployed in Michigan but Michigan has snow but Florida does not. Because it is extremely challenging for a human programmer to understand many implicit limitations of M(L), the mapping ƒ that the human handcrafts typically makes M(ƒ(L′)) fail, resulting in the well-known high brittleness of symbolic systems.

Due to emergent representations as numeric vectors, a DN robot discussed below learns snow settings and the snow concept when it sees snow scenes for the first time, because there are no symbols that correspond to snow in DN's representations.

In general, the developmental methods to be discussed below automatically address such new concept problems without a need for a human programmer to be in the loop of handcrafting a symbolic mapping ƒ during a deployment. In this paper, the author will further argue that the symbolic school suffers from human PSUTS.

### B. Connectionist School

The connectionist school claimed to be less brittle [8], [9]. However, a network is egocentric meaning that the agent starts from its own (neural) network, instead of a symbolic world. It must learn from the external world without a handcrafted, world-centered object model. Although connectionist methods often assume some task-specific symbols, e.g., a static set L of object labels, they also assume a restricted world implicitly. Therefore, a connectionist model typically needs to sense and learn from a restricted world using a network. The use of L by any neural networks (e.g., ImageNet [10] and many other competitions) as a set of object labels is a fundamental limitation that also causes the resulting system to be brittle for the same reason as the symbolic school.

Typically, a neural network is meant to establish only a mapping ƒ from the space of input X to the space of class labels L,

$$f : X ↦ L \qquad ( 1 )$$

[11], [12]. X many contains a few time frames. Many video analysis problems, speech recognition problems, and computer game-play problems are also converted into this static input space so that the input space also includes L, so as to learn

$$f : X \times L ↦ L . \qquad ( 2 )$$

Without a pressure of performance characterization during learning other than the performance of the final network, a self-organization map (e.g., SOM) has been used often as an unsupervised but slow learning method [13], [14], [15].

In contrast, with a pressure of performance characterization during learning, Cresceptron [16] used a “skull-closed” incremental-learning Hebbian-like scheme with receptive-field based competitions.

Other than the Hebbian mechanisms which are strictly “unsupervised” used by he Cresceptron and the DN explained below, two other types of learning schemes have been published:
(A) Human handpicking features: after knowing the test set, humans handpick features, reported explicitly [17], [18], [19] or implicitly as “weakly supervised” [19]. This author called them “skullopen” [20].
(B) Error-backprop: Locally train multiple networks each from a different set of random weights. After the training, post-select the luckiest network. Report the luckiest network only [21], [22], [23], [24], [25], [26], [27], [28], [29], [30], [31], [32], [33], [34], [35], [36], [37], [38] but many publications do not report the post-selection stage at al, with few exceptions [27].

Below, this author will argue that (A) suffers from human Post-Selections and (B) suffers from machine Post-Selections. While Cresceptron, the first deep learning for a 3D world, generates a single large network, it showed an impressive generalization power due to the use of the nearest neighbor scheme at every layer of an automatically generated deep network. This author will argue that Post-Selections in (A) and (B) suffer from weak generalizations (due to three types of lucks to be discussed below) and did not count the cost of training multiple networks many of which were not reported.

By the way, genetic algorithms offer another approach to such network learning. These algorithms study changes in genomes across different life generations. However, many genetic algorithms do not deal with lifetime development [39], [40]. We argue that handcrafting functions of a genome as a Developmental Program (DP) seems to be a clean and tractable problem, which avoids the extremely high, cost of evolution on DP. Many genetic algorithms further suffer from the PSUTS problems, since they often use test sets as training sets (i.e., vanished tests) as explained below.

Marvin Minsky [5] among many scholars complained that neural networks are “scruffy” or “black boxes”. This problem is not addressed holistically until the framework of Emergent Turing Machine was introduced [41] into Developmental Networks (DNs) by the Developmental School discussed below. A lack of Emergent Turing Machine mechanisms or being “scruffy” in sample fitting appears to be the main cause of PSUTS in traditional neural networks trained by human feature-handpicking or error-backprop methods.

Reinforcement learning does not address the Post-Selection problems. The problems of Post-Selection discussed below also defeat reinforcement learning (e.g., Q-learning) that uses symbolic states (which added values). For the problems of symbolic states in reinforcement learning, see criticisms in [42] which presents biologically inspired reinforcement learning in the Developmental Networks using emergent (vector) states.

### C. Developmental School

The main thrust of the Developmental School, formally presented 2001 by Weng and six co-authors [39] is the task-nonspecificity for lifetime development, known as Developmental Programs (DPs) that simulate the functions of genome without simulating the genome encoding. Although a DP generates a neural network, a DP is very different from a conventional neural network in the evaluation of performance across each life—all errors from the inception time 0 of each life is recorded and reported up to each frame time t>0, as explained further below.

The first developmental program seems to be the Cresceptron by Weng et al. [43], [44], [16] which appears to be, as far as the author is aware, the first deep-learning Convolutional Neural Network (CNN) for a 3D world. As explained in [45], [46] other well-known CNNs for 3D recognition, although they do not use a generative DP, followed many key ideas of Cresceptron. Cresceptron seems to be the first incremental neural network whose evaluation of performance is across its entire “life” and only one network was generated (developed) from the given training data set. Cresceptron did not deal with time.

In 2000, the inventor published with six (6) co-authors what is called “Autonomous Mental Development (AMD)” in Science [39]. The Science editor commented that developmental AI had not been not known before—the article published a new direction “task-nonspecific programs across lifetime”, called Developmental Programs (DPs). All programs before then were task-specific, including all published neural networks due to PSUTS to be explained below.

Although a DP generates a neural network, a DP is very different from a conventional neural network in evaluation of performance across each life—all errors from the inception time 0 of each life is recorded, reported up to each current time t>0 and taken into account in the performance evaluation, as explained further below.

A series of advances has been made since 2000. The following is only an outline of the most important events. For a more detailed account of the entire picture the reader is referred to a book by the inventor [47].

In 2005, the inventor and his co-worker presented what is called Lobe Component Analysis (LCA) [48]—a model for a general-purpose neuronal area for AMD. As far as the inventor is aware, the LCA is the first biologically inspired theoretical model for a general-purpose neuronal area that is optimal in both space and time, in the sense of maximum likelihood (ML). By space, we mean neurons in a brain area is ML-optimally distributed at any time during lifetime learning; by time, we mean neurons move to the ML-optimal target in the shortest time across the lifetime. Many later AI researchers (cited below) not being aware of (or not willing to cite and use) the dually optimal LCA, resulting in the Post-Selections Using Test Sets (PSUTS) controversy presented in this invention.

This comparison between AI and physics assumes that quantum phenomena to physics are like brain phenomena to AI. The same assumption applies below.

Three years later, 2008, the inventor and coworkers presented “top-down connections enables abstract representation” [49]. As far as the inventor is aware, this is the first solution to how brains abstract. Two years had passed, the inventor and coworker presented a network's “intent emerges sequentially (e.g., attend to a spatial location or an object type when it looks at any cluttered natural scenes)” [50]. As far as the inventor is aware, this is the first general model how brains attend any cluttered scenes.

In 2017, the inventor and his coworkers presented “emergent universal Turing machine” [51]. This is the first emergent mode about Auto-Programming for General Purposes (APFGP) along with experimental results.

In 2020, the inventor argued APFGP enables conscious machines, the first model about conscious machines that are based on emergent universal Turing machines [52].

A developmental approach that deals with space and time in a unfired fashion using a neural network started from Developmental Networks (DNs) [49] whose experimental embodiments range from Where-What Networks 1 (WWN-1) [53] to WWN-9 [54]. The DNs went beyond vision problems to attack general AI problems including vision, audition, and natural language acquisition as emergent Turing machines [41]. We overcame the limitations of the framewise mapping in Eq. (1) by dealing with lifetime mapping:

$$f \text{:} X ( t - 1 ) \times Z ( t - 1 ) ↦ Z ( t ) , t = 1 , 2 , \qquad ( 3 )$$

where X(t) and Z(t) are the sensory input space and motor input-output space, respectively, and × denotes the Cartesian product of sets. A fundamental difference between Eq. (2) and Eq. (3) is that in the latter the Z space contains exclusively emergent vectors, instead of any symbols, so that the actions/states are incrementally taught and learned across a lifetime.

Note that Z(t−1) here is extremely important since it corresponds to the state of a Turing machine. Namely, all the errors occurred during any time of each life is recorded and taken into account in the performance evaluation. Different from the space mapping in Eq. (1) and very important, the space Z(t) is the directly teachable space for the learning system, inspired by brains [55], [56], [57], [58], [56], [59]. This new formulation is meant to model not only brain's spatial processing [60] and temporal processing [61], but also Autonomous Programming for General Purposes (APFPG) [62], [51]. Based on the APFGP capability, the AI field seems to have a powerful yet general-purpose framework towards conscious machines [52].

We need to consider two factors: (A) Space: Because X and Z are vector spaces of sensory images and muscle neurons, we need internal neuronal feature space Y to deal with sub-vectors in X and Y and their spatial hierarchical features. (B) Time: Furthermore, considering symbolic Markov models, we also need further to model how Y-to-Y connections enable something similar to higher and dynamic order of time in Markov models. With the two considerations (A) Space and (B) Time, the above lifetime mapping in Eq. (3) is extended to:

$$f \text{:} X ( t - 1 ) \times Y ( t - 1 ) \times Z ( t - 1 ) ↦ Y ( t ) \times Z ( t ) , t = 1 , 2 , \qquad ( 4 )$$

It is worth noting that Z(t−1) here is extremely important since it corresponds to the state of a Turing machine as we will see below. Asim Roy [63] argued that there are some parts of the brain that control other parts. Here the area Z could be treated as a regulatory “controller” that regulates hidden neurons in the Y, e.g., as sensorimotor rules. In neuroscience, where have been many published models that handcraft areas as top-down regulators. In the DN model below, such areas must be automatically generated and refined ML-optimally inside the closed skull across lifetime.

In terms of performance evaluation, all the errors occurred during any time in Eq. (4) of each life is recorded and taken into account in the performance evaluation.

Different from the static symbols in the symbolic school and the space of class labels L of static symbols in Eq. (2) of the connectionist school, the space Z(t) of numeric vectors of the developmental school is free from symbols. Therefore, these states/actions are directly teachable or self-generative, inspired by brains [64], [55], [56], [57], [58], [56], [59]. This new symbol-free formulation is necessary to model not only brain's spatial processing [60] and temporal processing [61], but also Autonomous Programming for General Purposes (APFPG) [51]. Based on the APFGP capability, we open the door towards the next step—conscious learning [52]—learning while being partially and increasingly conscious. By conscious learning, we do not mean “open-skulledly” handcrafting general-purpose consciousness, which is probably too complicated to handcraft. But instead we enable fully autonomous machine learning while machines being partially conscious—autonomously learn more sophisticated consciousness skills using their partial, earlier, and simpler conscious skills across the lifetime.

Here, this inventor presents a controversial practice called Post-Selection. This report also explains why the inventor's brain model (Developmental Networks, DNs) avoids Post-Selection. Using Post-Selections means at least the corresponding project wastes much resource of computation and manpower and the superficial error of the reported system is misleading because the system does not give a similar error on new data sets. This invention not only raised a controversy but also presented a solution to avoid Post-Selections.

Since 2012, AI has attracted much attention from public and media. A large number of projects in AI have published [24], [25], [26], [27], [26], [28], [65], [66], [30], [29], [67], [30], [31]. If the authors of these projects use the method of this report, they could benefit much for reducing the time and manpower used to reach their target systems as well as improving the generalization powers of their target systems.

Let us first discuss in Sec. I what Post-Selections are. Sec. II reasons why error backprop needs PSUTS. Sec. III provides details of the Post-Selection free methodology. Sec. IV outlines experiments. Sec. V presents concluding remarks.

### BRIEF SUMMARY OF THE INVENTION

This invention raises a rarely reported practice in Artificial Intelligence (AI) called Post-Selections which appear to be rampant, such as neural networks, reservoir computation, swam intelligence and evolutionary computation. Post-Selections mean selections of a system to report after multiple systems have been trained because the resulting networks are selected to report because of their luck, not because of their intrinsic mechanisms for generalization. All post-selections have a weak generalization power. Due to a need for Post-Selections, all such AI methods lack a good generalization power. All PSUTS fall into two kinds, machine PSUTS and human PSUTS. This invention analyzes why, all methods that use Post-Selections suffer from severe local minima, why Post-Selections violate technical protocols, and publications that used any Post-Selections should have transparently reported the Post-Selection stage. For transparency in future publications and products, this invention proposes what is called developmental errors about all networks trained in any machine-learning projects, as a new technique for performance evaluation in machine learning, along with Four Learning Conditions: (1) a body including sensors and effectors, (2) a set of restrictions of learning framework, including whether task-specific or task-nonspecific, batch learning or incremental learning; (3) a training experience and (4) a limited amount of computational resources including the number of hidden neurons. The developmental errors trace the trajectory of performance across the machine-learning “lifetime” for every network trained. This invention also discusses how the brain-inspired Developmental Networks (DNs) do not need post-selections by reporting developmental errors and its maximum likelihood (ML) optimality under the Four Learning Conditions. DNs are not “scruffy” because they are ML-estimators of an incrementally observed and internally-emergent Turing Machine at every time frame of their machine-learning “lives”. Namely, every trained machine gives the best performance.

### BRIEF DESCRIPTION OF THE DRAWINGS

The patent or application file contains at least one drawing executed in color. Copies of this patent or patent application publication with color drawing(s) will be provided by the Office upon request and payment of the necessary fee.

FIG. 1 is a 2D-terrain illustration for the global minima problems in a high-dimensional terrain (e.g., 200B-dimensional space of hyper parameters and weights) where TM means Turing machine.

FIG. 2 is two annotated windows for an object class labeled as “steel drum” for single object localization with figure courtesy of [68].

FIG. 3 is Table 2 from Kriszhevsky & Hinton 2017 [69].

FIG. 4 is a piece of evidence, copied from [70], where PSUTS was probably used instead of PSUVS because the test data are better than the validation data.

FIG. 5 is an illustration about lack of role-determination in hidden neurons due to a lack of competition with color sample images courtesy of [68].

FIG. 6 is an illustration about how competition automatically assigns roles among hidden neurons without a central controller with sample images courtesy of [68].

FIG. 7 is a figure where a Turing machine has a tape, a read-write head, and a transition function with a current state.

FIG. 8 is a comparison of error between the luckiest CNN trained by batch error-backprop and a DN across different epochs through the fitting data, adapted from [71].

### DETAILED DESCRIPTION OF THE INVENTION

### I. Post-Selections

In statistics, inference post a model selection [72] means from a given data set, a human manually selects a model, and then the selected model is applied to the data set to conduct inference. Although this practice is allowed as a computer assisted manual process in statistics, post-selection is inconsistent with the well-accepted principle of AI, since AI is not widely considered a manual process. The Post-Selection issue here is very different from the post model selection topic in statistics.

AI has made impressive progress, gained much visibility, and attracted the attention of many government officials. However, there are protocol flaws that have resulted in misleading results.

First, let us consider three learning conditions that any fair comparisons of AI methods should take into account.

### A. The Four Learning Conditions

Many AI methods were evaluated without considering how much computational recourses are necessary for the development of a reported system. Thus, comparisons about the performance of the system have been tilted toward competitions about how much resources a group has at its disposal, regardless how many networks have been trained and discarded, and how much time the training takes.

Here we explicitly define the Four Learning Conditions for development of an AI system:

Definition 2 (The Four Learning Conditions): The Four Learning Conditions for developing an AI system are: (1) A body including sensors and effectors, (2) a set of restrictions of learning framework, including whether task-specific or task-nonspecific, batch learning or incremental learning, (3) a training experience and (4) a limited amount of computational resources including the number of hidden neurons.

The competing standard of the ImageNet competitions [68] did not include any of these four conditions. The AIML Contests [73] considered all the four in performance evaluation. In the following Subsection, we discuss why task-nonspecificity and incremental mode should be considered in any comparisons.

B. Task-Specific vs. Task-Nonspecific

A task-specific learning approach learns less because much is handcrafted by a human according to the given task. Furthermore, a task-specific method is brittle.

In Condition (1) of the Four Learning Conditions, the task-nonspecific learning paradigm is significantly different from the task-specific traditional AI paradigm as explained in Weng et al. 2001 [39]. In a task-specific paradigm, the system developer is given a task e.g., constructing a driverless car. Then, it is a human programmer who chooses a world model, such as a model of lane edges. Next, he picks an algorithm based on this world model, e.g., the well-known Hough transform algorithm [74], [75] for line detection which makes every pixel that is detected as edge cast votes for lines of all possible orientations o and distances d from the origin that go through the pixel. Then the top-two “peaks” of line parameters (o, d) that have received the highest votes are adopted to declare a line detected from the image. Here “edges” and “lane lines” are two symbolic concepts picked up by the programmer. Such systems will fail when lanes are unclear or totally disappear due to weather or road conditions, leading to a brittle system. Human brains appear to be more resilient.

Even a highly specific task in ImageNet [68] cannot be done well if a learning system is task-specific—restricted to ImageNet task specifications. For example, why “stripe shirts” are classified as “zebra”? Because ImageNet data sets are meant to drop “stripe shirts” in favor of the “zebra” class. Recognition must recognize “wholes” from “parts”, but ImageNet annotations do not provide parts annotations. All such information and more are beyond the ImageNet specifications.

In contrast, a task-nonspecific approach [39] not only avoids any symbolic model, but also does not requires that a task is given. The desirable actions at any time are taught, tried, and recalled automatically by the learner based on system's learned context q [47] that includes automatically figured-out goal and state, as well as the current input. The mapping function ƒ(z, x)=z′, representing the symbolic mapping ƒₛ(q, σ)=q′, corresponds to a finite automaton. Weng has proven that the control of any Turing machine is a finite automaton [41]. Thus, this framework is of general-purposes in the sense of universal Turing machines. Any universal Turing machine is of general purposes, because it can read any program written for any purposes and run it for the purposes. Any neural network that learns a universal Turing machine become of general purposes in the sense of any programs, not just in the sense of any mappings like that in Eq. (1). Thanks to the absence of any world model, such as lanes, this task-nonspecific approach has a potential to be more robust than a world-model based approach. The task-nonspecific approach typically uses a neural network to learn because the need to learn vector mapping function ƒ(z, x)=z′. We will discuss internal response vector y in Section III but task-nonspecificity holds true without y.

It is worth noting that providing training set to all teams does not mean the same training experience, e.g., incremental learning vs. batch learning and the number of times to pass through the data set. See more discussion below. On the other hand, superficially stating what processors and accelerators were used does not address the network size problem as the critical computational resources here.

C. Batch vs. Incremental Learning Modes

Neural network learning for the mapping ƒ has two learning modes, batch learning and incremental learning.

With batch learning, a human first collects a set D of data (e.g., images) and then labels each datum with a desirable output (e.g., command of navigation or class label). A neural network is trained to approximate a mapping ƒ in Eq. (1) or Eq. (2). Many batch-learning projects use an error-backprop method [23], [76], [24] which uses a gradient-based method to find a local minimum in error.

As we will discuss in Section II, the gradient in the error-backprop method does not contain key information of many other data if the learning mode is incremental. Thus, error-backprop on a large data set does poorly using a purely incremental learning mode. Many used a block-incremental learning mode which suffers from the big data flaw in Theorem 1 below.

In contrast, all developmental methods cited here use incremental learning mode for long lifetimes, using a closed-form solution to the global lifetime optimization. The competition among neurons guarantees that the winner is the most appropriate neuron whose memory corresponds to the current working memory [48].

However, the batch and incremental learning modes are not capability-equivalent [48]. The former requires all sensory inputs are available at a batch, independent of the corresponding actions. Therefore, the former is easier and also incorrect according to sensorimotor recurrence. By sensorimotor recurrence, we mean that sensory inputs and motor outputs are mutually dependent on each other in such a recurrent way that off-line collection of inputs are technically flawed. We have the following theorem:

Theorem 1 (Big Data Flaw): All static “big data” sets used by machine learning violate the sensorimotor recurrence property of the real world.

Proof: A learning agent at time t−1, as shown in Eqs. (3) and (4) does not have the next sensory input from X(t) available before the corresponding actions in Z(t−1) are generated and output, since the sensory input in X(t) varies according to the agent actions in Z(t−1). As an example, turning head left or right will result in a different image sensed. Therefore, all static “big data” sets violate the sensorimotor recurrence.

One may say that classifications of static images are fine. We do not agree, because even when a human (or machine) is looking at a static image, he uses attention (e.g., context-based saccades)which is a sequence of actions. Each saccade results in a different fovea image.

Therefore, incremental learning is necessary for the sensorimotor recurrence. All batch-training methods use a static set of training data and, therefore, are inappropriate for any of them to claim near-human performance since the two learning problems are different. This leads to the following theorem.

Consider a hierarchy of levels of object types, such as nails, fingers, palms, hands, arms, limbs, torsos, human bodies, etc. Because vision requires a high level l to understand natural scenes with abstraction of parts with invariances (e.g., all fingers of different scales, looks, and at different locations), each child needs an open-ended world to learn to learn rules (e.g., finger-parts and hand-whole) instead of simple-minded pattern recognition of sensory images.

Theorem 2 (Nonscalability of Big Data without abstraction): All static “big data” sets used by machine learning are nonscalable if they are treated as pattern recognition without rule abstractions.

Proof: Suppose that a static data set D has shown the presence of k feature types defined at level 1 (e.g., edge pixels are a type). Suppose a combination of k>1 feature types to level l+1 type (e.g., straight line type is from multiple edge pixels) is defined from k types of feature types at level l, l=1, 2, . . . . The number of samples for a l-level feature type requires at least l^{k} observations to discover all necessary within-type equivalence (e.g., logic OR is at l=2 with k=2 logic features at l=1, thus without rule abstraction (e.g., parts and whole), it requires l^{k}=2²=4 observations, corresponding to rows in the truth table of logic OR). Since ƒ(l, k)=l^{k} is an exponential function in k, l^{k} quickly exceeds any fixed number of observations in the static data set D.

Rule abstractions deal with invariances. For example, a “what” concept is “where”-invariant and a “where” concept is “what”-invariant, as explained in [60], [50].

Section III discusses an optimal framework through which such abstractions can take place from learning simple rules during early life that enable learning of more complex rules during later life called scaffolding [77].

Theorem 2 leads to two observations on data fitting on a static data set:

Observation 1: Any data fitting on a static data set without learning invariant concepts are nonscalable, including the n-fold cross-validation discussed below. Unfortunately, data fitting on a static data set is a norm in all ImageNet Contests [76]. Namely, the remaining subsections in this section analyze approaches that are nonscalable. For example, computer vision is not a “one-shot” pattern classification problem as argued by Li Fei-Fei et al. [19] (which was questioned in PubMed without responses), but rather a spatiotemporal problem to learn various invariant concepts present in cluttered natural scenes through autonomous attention saccades, as explained further in Observation 2.

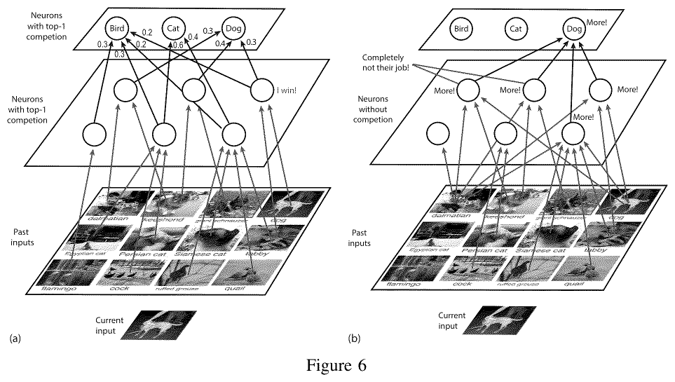

Observation 2: Learning invariant concepts seem nonscalable for any data fitting on a static data set either, because there are too many images to be labeled by hand (e.g., all pixel locations) [60], [50]. Like a human baby, any scalable machine learning methods must be conscious through which the machine learner must consciously guess concepts (i.e., not just active learning [78]) (e.g., an object type) and verify their invariance rules (e.g., the where-invariance of a what concept). The state-based transfer in Theorem 8 of [61] explains how each concept state reduces the number of samples to be learned from an exponential l^{k} down to only kl (see FIG. 6 of [61] for intuition where k=10 and l=3). Thus, Section III not only addresses the non-scalability problems in this section, but is also necessary for conscious learning whose theory was recently published in Weng 2020 [52] with some single-sensory-modality experimental results, but animal-level conscious robots that are multi-sensory and multi-motor have not yet been demonstrated. The availability of real-time learning brain-chip is a current bottleneck.

### D. Fitting, Validation and Test Errors

Given an available data set D, D is divided by a partition P=F∪V∪T into three mutually disjoint sets, a fitting set F, a validation set V, and a test set T so that

$$D = F ⋃ V ⋃ T . \qquad ( 5 )$$

Two sets are disjoint if they do not share any elements. The validation set is possessed by the trainer, the test set should not be possessed by the trainer since the test should be conducted by an independent agency. Otherwise, V and T become equivalent.

As we will see in Section II, given any architecture parameter vector aᵢ, it is unlikely that a single network initialized by a set of random weight vectors can result in an acceptable error rate on the fitting set, called fitting error, that the error-backprop training intends to minimize locally. That is how the multiple sets of random weight vectors come in. For k architecture hyper-parameter vectors aᵢ, i=1, 2, . . . k and n sets of random initial weight vectors wⱼ, the error back-prop training results in kn networks

$$\{ N ( {a}_{i} , {w}_{j} ) \vert i = 1 , 2 , ... , k , j = 1 , 2 , ... , n \} .$$

Error-backprop locally and numerically minimizes the fitting error ƒ_{i,j} on the fitting set F.

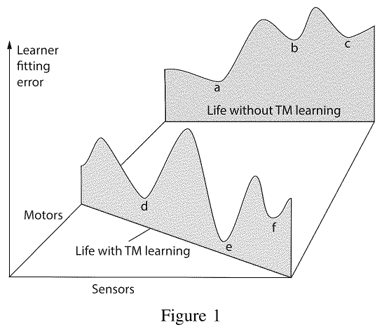

FIG. 1 gives a 2D illustration for the limitations of Post-Selection as well as the difference between the sensor-only mapping in Eq. (1) and the sensorimotor mapping in Eq. (3). Suppose X represents the space of sensory input and Z represents the space of motor input, but in general should be any initial pair (aᵢ, wⱼ). Each location on the 2D plane of Eq. (1) corresponds to the initial random weights of a neural network (e.g., 200B-dimensional). Of course, each network has many neurons not just two input values but FIG. 1 can only schematically represent the initial weights of two values as a 2D-terrain illustration. The height of a curve at is the system fitting error e_{i,j} of a particular trained network N(aᵢ, wⱼ). We use the term “life” to indicate the entire process of a system's learning.

The error-backprop learning method is a greedy method. Starting from any initial pair (aᵢ, wⱼ) it steps along the direction that descends the quickest without knowing where the global minimum is in the 200B-dimensional space. In FIG. 1, we can see that (aᵢ, wⱼ) leads to a local minimum a, b, or c if we use the sensory mapping in Eq. (1). The point a is the lowest point, but there is no guarantee to reach it, depending on where the network starts from in the 200B-dimensional space. The more networks have been trained, the more likely the luckiest network finds the global minimum. In FIG. 1, the luckiest network starts from the valley where a is located, but this is much harder for the 200B-dimensional space. Typically, the more networks a project has trained, the more likely for the Post-Selected stage to find a network with a smaller e_{i*,j*}.

Graves et al. [27] seems to have mentioned that the number of trained systems is at least n=20. Saggio et al. [33] reported that n is at least 10,000. Krizhevsky & Hinton [69] did not give n but seems to have mentioned 60 million parameters which probably means each wᵢ and each aⱼ combined to be of 60 million dimensional. Using an example of l^{k}=3¹⁰=59049 and n=20, l^{k}n≈1M networks must be trained, a huge number that requires a lot of computational resources to do number crunching and a lot of manpower to manually tune the range of hyper-parameters.

Definition 3 (Distribution of fitting, validation and test errors): The distributions of all kn trained networks' fitting errors {ƒᵢⱼ}, validation errors {eᵢⱼ}, and test errors {eᵢⱼ′}, i=1, 2, . . . k, j=1, 2, . . . n are random distributions depending on a specific data set D and its partition P=F∪V∪T. The difference between a validation error and a test error is that the former is computed from the same group using a group-possessed validation set V but the latter is computed by an independent agency using a group-unknown test set T.

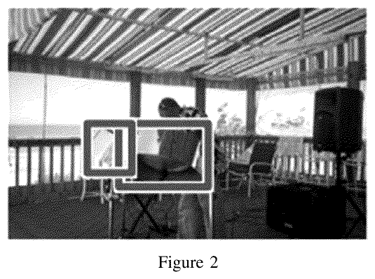

We define a simple system that is easy to understand for our discussion to follow. Consider a highly specific task of recognizing patterns like those in annotated windows in FIG. 2. This is a simplified case of the three tasks—recognition (yes or no, learned patterns at varied locations and scales), detection (presence of, or not, learned patterns) and segmentation (of recognized patterns from input) from natural cluttered scenes dealt with by the first deep learning networks for 3D-Cresceptron [16]. Later data sets like ImageNet [68] contain many more samples.

Definition 4 (Nearest neighbor classifiers with a distance threshold): Define a network that stores the entire fitting set F where each image in F may contain multiple annotated windows for matching (see FIG. 2). For each input image q, a scan subwindow x searches across the input image q for a range of locations and scales, normalizes the scale, and compares with each annotated window in F. Suppose an input window x matches the nearest sample (annotated) window s in F. If the distance between x and s is not larger than a distance threshold d (a hyper-parameter), then the network outputs the associated label of the nearest sample s. Otherwise, the system outputs a label randomly and uniformly sampled from the label set L.

Namely, this system uses a lot of resources for over-fitting. It randomly guesses if the distance is larger than d, but has a perfect fitting error (zero).

A typical neural network architecture has a set of hyper parameters represented by a vector a, where each component corresponds a scalar parameter, such as convolution kernel sizes and stride values at each level of a deep hierarchy, the neuronal learning rate, and the neuronal learning momentum value, etc. Let k be a finite number of grid points along which such architecture parameter vectors need to be tried, A={aᵢ|i=1, 2, . . . , k}. Suppose there are 10 scalar parameters in each vector aᵢ. For each scalar parameter x of the 10 hyper parameters, we need to validate the sensitivity of the system error to x. With uncertainty of x, we estimate its initial value as the mean x̅, positively perturbed estimate x̅+σₓ(σ is the estimated standard deviation of x), and negatively perturbed estimate x̅−σₓ. If each scalar hyper parameter has three values to try in this way, there are a total of k=3¹⁰=59049 architecture parameter vectors to try, a very large number. For example, the initial threshold d in the nearest neighbor classifier can be estimated by the average of nearest distance between a sample in V and the nearest neighbor in F and the σ_{d} be estimated by the standard deviation of these nearest distances.

Let us define the Post-Selection. Ideally, test sets should not be in the possession of authors, e.g., during a blind test. However, this is often not true since the authors may use publically available data sets that include test sets. Suppose that the validation sets and the test sets are in the possession of the human programmer.

Definition 5 (Post selection): A human programmer trains multiple systems using the fitting set F. After these systems have been trained, the experimenter post-selects a system by searching, manually or assisted by computers, among trained systems based on the validation set V (or the test set T). This is called Post-Selection-selection of one network from multiple trained and verified (or tested) networks.

Obviously, a post-selection wastes all trained systems except the selected one. As we will see next, a system from the post-selection tends to have a weak generalization power.

First, consider Post-Selections:

### E. Post-Selections

A Post-Selection can use the validation set V or the test set T. However, if both sets are in the possession of the human programmer, the difference between V and T almost totally vanishes under Post-Selections.

1) PSUVS: A Machine PSUVS is defined as follows: If the test set T is not available, suppose the validation error of N(aᵢ, wⱼ) is e_{i,j} on the validation set V, find the luckiest network N(a_{i*}, w_{j*}) so that it reaches the error of the luckiest-architecture and the luckiest initial weights from Post-Selection on Validation Sets:

$${e}_{{i}^{*} , {j}^{*}} = {min}_{1 \leq i \leq k} {min}_{1 \leq j \leq n} {e}_{i , j} \qquad ( 6 )$$

and report only the performance e_{i*,j*} but not the performances of other remaining kn−1 trained neural networks.

Similarly, a human PSUVS is a procedure wherein a human selects a system from multiple trained systems for {e_{i,j}} using human visual inspection of internal representations of the system and their validation errors.

Next, we discuss Post-Selections Using Test Set (PSUTS). There are two kinds of PSUTS, machine PSUTS and human PSUTS.

2) Cross-Validation: The above PSUVS is an absence of cross-validation [79]. Originally, the cross-validation is meant to mitigate an unfair luck in a partition of the dataset D into a fitting set F and a test set T (empty validation set). For example, an unfair luck is such that every point in the test set T is well surrounded by points in the fitting set F. But such a luck is hardly true in reality.

To reduce the bias of such a luck, an n-fold cross-validation protocol, n≥2, divides the data set D into n subsets of same size and conducts n experiments. The term “cross” refers to switching the roles of fitting and testing data. In the i-th experiment, the i-th subset is left out as the test set and the remaining n−1 folds of data form the fitting set. Thus, the cross-validation protocol conducts n experiments, for i=1, . . . , n, to obtain n errors, e₁, e₂, . . . , eₙ. The cross-validated error is defined as the average of errors from the n tests, to filter out the partition lucks:

$$\overline{e} = \frac{1}{n} {\sum }_{i = 1}^{n} {e}_{i} \qquad ( 7 )$$

as well as the distribution of errors {eⱼ}.

The n different numbers here shows a distribution show a distribution {eⱼ} to indicate how sensitive the error is to lucks, such as the number of partition pairs between a fitting set and a validation/test set, the number of tried random seeds for initializing network weights, the number of tried hyper-parameter vectors, or a combination thereof. The larger the n, the better the estimated standard deviation of {eⱼ}.

Although Post-Selections have been used by many different kinds of AI method, let us discuss neural networks as a common type of learning agents.

### F. Types of Lucks in a Network

In a neural network, there are at least three kinds of lucks:

Type-1 order lucks: The luck in a partition Pᵢ into a fitting set Fᵢ and a test set Tᵢ from a data set D resulting in test error eᵢ, i=1, 2, . . . n. Different partitions correspond to different luck outcomes. This kind of outcome variation results in a variation of performance from different outcomes. Conventionally, this type of lucks is filtered out by cross-validation (e.g., n-fold cross-validation) as well as reporting the deviation of {eᵢ} during the cross-validation. However, such cross-validation and deviation have hardly published for neural networks and reported. The smaller the average e of {eᵢ}, the more accurate the trained network is; the smaller the standard deviation of {eᵢ}, the more trustable the average error ē is.

Type-2 weights lucks: As we will discuss below, weights specify the role assignment for all the neurons in the neural network. A random seed value determines the initialization of a pseudo-random number generator, which gives initial weights wᵢ for a neural network N(wᵢ), resulting in a test error eᵢ, i=1, 2, . . . n, after training of these n networks and testing on T. It is unknown that such a luck will be carried over to a new test set T′ that is outside the data set D but was drawn from the same distribution of S. Because a neural network might not capture the internal rules of the fitting set F, this paper argues that a statistical validation of the reported error should be performed by reporting the distribution of {eᵢ|i=1, 2, . . . n}, where eᵢ is from a different initial weight vector wᵢ. For example, Krizhevsky et al. [69] reported 60 million parameters, mostly in wᵢ but only the luckiest eᵢ was reported. The smaller the average ē of {eᵢ}, the more accurate the trained network is; the smaller the standard deviation σ of {eᵢ}, the less sensitive the trained neural network is to the initial weights and thus the accuracy is more trustable for real applications. For i.i.d. (identically independently distributed) errors, we can expect that doubling the number n will reduce the expected variance of ē by a factor 1/\sqrt{2}, since the expected variance of n random numbers is about σ²/n.

Type-3 architecture lucks: The initial hyper-parameter vector aⱼ of the neural network gives an error eⱼ, j=1, 2, . . . k. Because such a luck of aⱼ might not capture the internal rules of the fitting set Fⱼ, this paper argues that a statistical validation of the reported error estimate should be performed and the distribution of {eⱼ} be reported. In our above example, the number of distinct hyper-parameter vectors to be tried is k=3¹⁰=59049. The smaller the average a of {eⱼ}, the more accurate the trained network is; the smaller the sample variance of {eⱼ}, the more trustable e is, namely, the average error ē is less sensitive to the initial hyper-parameters of the network. For example, the threshold d of the nearest neighbor classifier in Definition 4 might result in a large deviation. A good way is to reduce the manual selection nature of such hyper-parameters. For example, all hyper-parameters are adaptively adjusted from the initial hyper-parameters that are further automatically computed from system resources, e.g., the resolution of a camera, the total number of available neurons, and the firing age of each neuron [48].

For notation clarity in the discussion that follows, index j is used in Type 3 to distinguish index i in type 2, but the above three types of lucks are all different.

Let us discuss the case of a developmental network, such as Cresceptron [16] and DN [41]. Type-1 cross-validation is not needed because of reporting of a lifetime error. In other words, errors of all new tests in each life are taken into account throughout the lifetime. Type-2 validation is not needed because all different random weights wᵢ leads to the function-equivalent neural network under certain conditions. For example, in top-k competition, with k=1 different wᵢ give the exactly the same neural network and with k>1 different wᵢ give almost the same neural network. The distribution of lifetime errors {eᵢ} is expected to have a negligible deviation across different initial weight vectors wᵢ, given the same Four Learning Conditions. Type-3 validation might be useful but is expected to be negligible since the most obvious parameters such as learning rate and momentum of learning rate is automatically and optimally determined by each neuron, not handcrafted, as in LCA [48]. The synaptic maintenance automatically adjusts all receptive fields [80], [81] so that the neural network performance is not sensitive to the initial hyper-parameters.

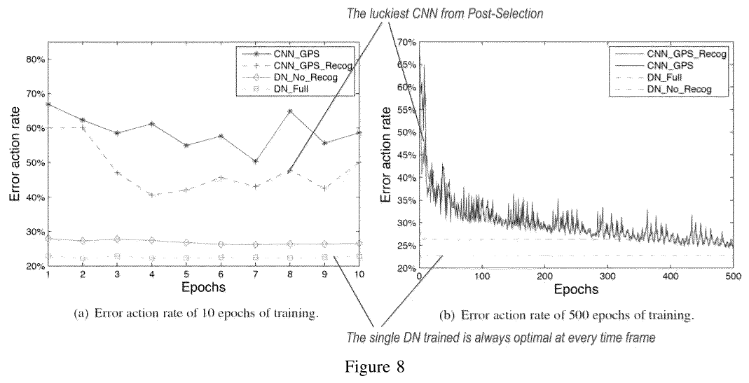

In contract, a batch-trained neural network typically uses a Post-Selection to pick the luckiest network without cross-validation for either of the above three types of lucks, e.g., in ImageNet Contest [68]. Namely, errors occurred during batch training of the network before the network is finalized and how long the training takes are not reported. Below, FIG. 8 will show a huge difference between the luckiest CNN with error-backprop and the optimal DN. Many researchers have claimed error-backprop works without providing much-needed three types of validations.

Next, let us discuss Types 2 and 3 validations which are new for neural networks but hardly done.

G. Post-Selection with Types 2 and 3 Average-Validations

Type-1 cross-validation should be nested inside the Types 2 and 3 validations, but this triple-nested protocol could be too computationally expensive. Below, we delay Type-1 cross-validation till after Type 2 and Type 3 validations.

Assume that we use n random weight vectors wᵢ and k grid-search hyper parameters aⱼ. Each combination of wᵢ and aⱼ gives an error e_{i,j} from the corresponding validation set. To reduce the effect of such a luck for each vector wᵢ, an average of e_{i,j}, over n values of i in Eq. (6) should be used instead of the minimum in Eq. (11). This leads to the random-weights validated error for the luckiest architecture from PSUVS:

$$a * = arg {min}_{1 \leq j \leq k} \frac{1}{n} {\sum }_{i = 1}^{n} {e}_{i , j} . \qquad ( 8 )$$

We dropped the term “cross” because this validation examines other random seeds without switching the roles between training and testing.

Similarly, we define the hyper-parameter validated luckiest initial weights from PSUVS:

$$w * = arg {min}_{1 \leq i \leq n} \frac{1}{k} {\sum }_{j = 1}^{k} {e}_{i , j} . \qquad ( 9 )$$

We dropped the term “cross” for the same reason.

From a statistical point of view, the initial hyper parameter vector a* and the random initial weights w* validated above through averages should be more robust in real applications than those without average-validation in Eq. (6).

For both the luckiest a* and w*, the standard deviation under min should be reported to show how sensitive the reported performance is to the validation process. If the variation is large, the corresponding network is not very trustable in practice.

We also need to be aware of another protocol flaw: Random seeds and hyper parameters are all coupled. Under such a coupling, Type 2 validation seems unnecessary with n=1 but the search of the luckiest weights is embedded into the search for the luckiest hyper-parameter vector where each hyper parameter vector uses a different seed. Similarly, Type-3 validation seems unnecessary with k=1 but the search of the luckiest hyper-parameter vector is embedded into the search for the luckiest weights, where each random seed uses a different hyper parameter vector.

Since a PSUVS procedure picks the best system based on the errors on the validation set, the resulting system might not do well on the test sets because doing well on a validation set does not guarantee doing well on a test set. Typically, due to a very large number of samples, availability of validation sets and unavailability of test sets in a properly managed contest, principles of Post-Selection should cause the validation error rate to be smaller than the test error rate. (However, in Table 2 of [69], the test error rate is smaller than the validation error for 7CNNs, causing a reasonable suspicion that PSUTS could be used instead of PSUVS.)

The following subsection discusses the luckiest network with the luckiest hyper-parameter vector a* and the luckiest initial weights w*.

H. The Luckiest Network from a Validation Set

Many people may ask: Are there any technical flaws in at least PSUVS, since it does not use the test sets? We analyze the luckiest network in this section and reach a conclusion that any post-selection is technically flawed and results in misleading results, including both PSUVS and PSUTS. However, in general, Type-1 cross-validation is to filter out lucks in data partition that a typical user does not have during a deployment of the method. Namely, it is a severe technical and protocol flaw in reporting only the luckiest network, regardless the post-selection uses validation sets or test sets.

This conclusion has a great impact on evolutional methods that often report only the luckiest network, instead of those of all networks in a population. Namely, the performances of all individual networks in an evolutionary generation should be reported.

For simplicity, we assume that the space S, from which random samples in D are drawn, is static. Our conclusions here can be readily extended to a time varying D but the technical flaws are even worse.

From the sample space S, randomly draw a data set D. D is partitioned into three mutually disjoint sets, fitting set F, validation set V and test set T, so that Eq. (5) holds true. For realistic applications, we should assume that F, V and T are mutually independently drawn from S so that F, V and T are mutually independent. Identically independently distributed (i.i.d.) is a sufficient condition, but we do not need such a restrictive condition because temporal-dependency often occurs in lifetime development. Namely, we only need that any three vectors from F, V and T, respectively, are mutually independent.

Using the fitting set F, one trains nk networks, where n and k are the number of hyper-parameter vectors a's and random weight vectors w's, respectively, using a training algorithm (e.g., error-backprop),

$$N ( {a}_{i} , {w}_{j} ) ← {f}_{{a}_{i} , {w}_{j}} ( F ) . \qquad ( 10 )$$

This is like a teacher trains kn students in a class. The teacher knows that the fitting error on F does not predict the validation error well, due to the possibility of over fitting. One extreme example is the above nearest-neighbor classifier with distance threshold d=0.

The teacher then tests each N(aᵢ, wⱼ) on the validation set V to get e_{i,j}. This is like the teacher observes the performance of kn networks in a mock exam.

The teacher then post-selects and reports only the luckiest network N(a_{i*}, w_{j*}) whose validation error e_{i*,j*} is minimum in Eq. (6). This is like the teacher colludes with the Educational Test Service (ETS) so that the ETS only reports the luckiest network but not all remaining kn−1 networks to cover up.

I. Expected Error from the Luckiest Architecture

Suppose that a user has bought the luckiest network architecture N(a_{i*}, w_{j*}) and test on his new test data T′ randomly drawn from real world S, independent of V and T. The luckiest network N(a_{i*}, w_{j*}) that reached the minimum error rate in V does not mean that it reaches the minimum error rate on T′. We need to estimate the expected error rate of E(e(a_{i*}, w_{j*})|T′) on the new test set T′.

Theorem 3 (Expected error from the luckiest architecture): Suppose that during in-house evaluation, the Type-1 order lucks and Type 2 weight lucks are simulated by casting dice as multiple tests with the luckiest errors to be e(a_{i*}, w_{j*}), j=1, 2, . . . , n. Then, the expected error at the user end by casting dice for w on a new test set T′ is

$$E ( e ( {a}_{{i}^{*}} , w ) \vert {T}^{′} ) = \frac{1}{n} {\sum }_{j = 1}^{n} e ( {a}_{{i}^{*}} , {w}_{{j}^{*}} \vert T ) .$$

instead of

$$E ( e ( {a}_{{i}^{*}} , w ) \vert {T}^{′} ) = {min}_{1 \leq j \leq n} e ( {a}_{{i}^{*}} , {w}_{{j}^{*}} \vert T ) .$$

assuming the user's environment S′ and the in-house environment S are the same.

Proof: S=S′ means that the hyper-parameters a_{i*} from T can be inherited by T′. However, the user must cast dice for the Type-1 order lucks and Type 2 weight lucks. That is, w on the left side needs to be re-estimated. Without actually conducting the training and testing at the user end, the seller can use the existing in-house tests, e(a_{i*}, w_{j*}|T), j=1, 2, . . . , n. Without knowing the probability of each e(a_{i*}, w_{j*}|T), it is reasonable to estimate that each is equally likely. We must not take the expected error as min_{1≤j≤n} e(a_{i*}, w_{j*}|T) because the user needs to try its own luck on w on the left side. The above conclusion results.

The above theorem tells us that the error rate of the luckiest network from a single validation set in PSUVS is misleading without any data-partition validation. This is because the error rate is a random function, depending on not only many random initial weights, many hyper parameters, and local lucks of error-backprop (e.g., learning rates), but also a particular data-partition F∪V∪T). This seems especially true if the data D were made public and overworked during ImageNet 2010-2014 [68, p. 213].

In practice, when we report an error rate e(a_{i*}, w_{j*}) which is always a random number x, depending on how much hand tuning is done, how much computational resources are used for a large-scale search for the random seeds and hyper-parameters, as well as the validation or a lack thereof. We should also report the distribution of this random number x, such as the maximum, 75%, 50%, 25%, and the minimum value of x, over multiple fitting-and-testing pairs in cross-validation, random seeds and hyper-parameters. Otherwise, the error rate, if only as a single number x, is misleading, since users of this learning method or buyers of the luckiest network do not have the same partition luck.

One may argue that his luckiest number x for the architecture hyper-parameter vector is based on the validation set, the test set or a combination of both and therefore it is not falsely generated. However, his luckiest number x is based on Post-Selections from many trained systems after “seeing” their performances on the validation set, the test set or a combination of both. As FIG. 1 illustrated, his luckiest number x along “life without TM learning” cannot predict the performance during the deployment to real world that is in fact along “life with TM learning”.

Up to now, this author has not found any published papers that report not only the luckiest network from error-backprop but also Type-1, Type-2 and Type-3 validations. Many papers do not report the post-selection stage at all [24], [25], [26], [28], [29], [30], [31], [32], [33], [34], [35], [36], [37], [38], except [27], let alone whether the reported error is from the validation error V or the test set T.

### J. Machine PSUTS

If the test set T is available which seems to be true for almost all neural network publications other than competitions, we define Post-Selection Using Test Sets (PSUTS):

A Machine PSUTS is defined as follows: If the test set T is available, suppose the test error of N(aᵢ, wⱼ) is e_{i,j} on the test set T, find the luckiest network N(a_{i*}, w_{j*}) so that it reaches the minimum, called the error of the luckiest architecture and the luckiest initial weights from Post-Selection on Test Set:

$${e}_{{i}^{*} , {j}^{*}} = {min}_{1 \leq i \leq k} {min}_{1 \leq j \leq n} {e}_{i , j} . \qquad ( 11 )$$

Report only the performance e_{i*,j*} but not the performances of other remaining kn−1 trained neural networks.

Some researchers have claimed that the test data was “unseen” by trained systems when they were tested, but the network selector has seen their performances before making a selection.

Imagine that we want to remove lucks in the above expression, by using averages like we did in Eq. (7) to give the error of the luckiest architecture with validated weights from PSUTS:

$${a}_{* , {j}^{*}} = arg {min}_{1 \leq j \leq n} \frac{1}{n} {\sum }_{i = 1}^{k} {e}_{i , j} . \qquad ( 12 )$$

But the above error is still flawed since each term under minimization has peeked into test sets. Instead, it is better to use eᵢⱼ in Eq. (6) which does not use the test sets. Of course, the test error rate of eᵢⱼ in Eq. (6) tends to be larger than that from Eq. (11).

A similar discussion can be made for the error of the luckiest initial weights with validated architecture from PSUTS. Do not peek into test sets.

There are some variations of Machine PSUTS: The validation set V or F are not disjoint with T. If F=V, we call it validation-vanished PSUTS. If F=T, we called it test-vanished PSUTS.

In general, the more free parameters a network has, the more likely the network can report an artificially small error as in Eq. (11). That is why we need the computational resource and a learning experience in the Four Learning Conditions.

Although PSUVS has flaws of post-selection and a lack of three types of validation to be discussed below, the key difference between PSUVS and PSUTS does not guarantee that PSUVS reports a low error rate as PSUTS. In fact, it is expected that the luckiest network from PSUVS does better on a validation set V than on a test set T because the Post-Selection did not “see” the test set T but “saw” the validation set V. Likewise, it is expected that the luckiest network from PSUTS does better on the test set T than on a validation set V because the Post-Selection did not “see” the validation set V but “saw” the test set T. In the following paragraph, we discuss that this expectation is reversed in Table 2 of Krizevsky & Hinton 2017 [69, page 88]. This piece of evidence supports that Krizevsky & Hinton probably used PSUTS instead of PSUVS.

In ImageNet Contest 2012, the test sets were released to competition teams over 2.3 months ahead of the output-result submission date. Although the class labels were not attached to the test sets other than being available indirectly through an online test server provided by the contest organizers, it was not difficult to “crack” a test set by manually hand-labeling the test set. The authors Kriszhevsky & HiHintonnton of [69] wrote: “in the remainder of this paragraph, we use validation and test error rates interchangeably”. By “we cannot report test error rates for all the models that we tried” [69, page 88], there is no evidence to rule out what he meant was the possibly “cracked” test set is not necessarily exactly the same as the original test set.

Another interesting phenomenon that is consistent with the likely use of PSUTS instead of PSUVS is that the SuperVision Team of ImageNet Contest 2021 did not submit any output results for “the fine-grained classification task, where algorithms would classify dog photographs into one of 120 dog breeds” [68, footnote, p 214]. It appears that cracking “120 dog breeds” is harder than cracking “a list of object categories present in the image” where the class labels are all available in the provided training (fitting and validation) sets. The actual number of trained networks over random seeds and hyper-parameters was hardly reported. Kriszhevsky & Hinton 2017 [69] lacks due transparency about the post-selection stage.

Geoffrey Hinton admitted in his PubPeer response to questions raised on PubPeer towards [24] that Kriszhevsky & Hinton [69] reported only the “luckiest” network. They did not say that their Post-Selections used the validation set, the test set or both.

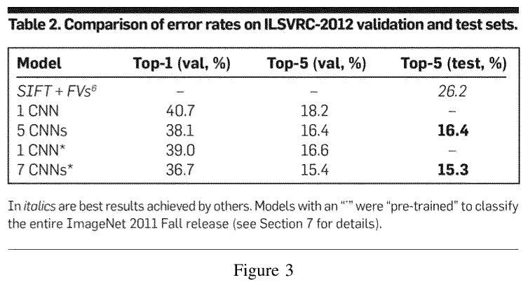

Here is a piece of direct evidence: Table 2 of Kriszhevsky & Hinton [69] copied to FIG. 3. In the last row “7 CNNs”, the test error 15.3% (100 images per class) is smaller than the validation error 15.4% (50 images per class). The ImageNet-reported numbers for the second and third bold numbers along the Top-5 (test %) column are 16.422 and 15.315, respectively. ImageNet provided on average 1000 fitting images for each test set; 1000 classes amounts to a little over 1000×1000=1,000, 000 images in the fitting set. Note the authors claimed the 7 CNNs were “pre-trained” to classify the entire ImageNet 2011 Fall release. The ILSVRC-2011 fitting set could be a subset of ILSVRC-2012 fitting set (increased 4.2%). The 100×1000=100,000 test images may change from 2011 to 2012 [68, Tables and 3] but the 1000 test-class labels should remain the same from 2011 to 2012. Thus, the luckiest network from Post-Selections for ILSVRC-2011 (e.g., that minimizes the sum of fitting error, validation error and test error) should be almost the luckiest for ILSVRC-2012 as only 4.2% images were added into ILSVRC-2012.

Imagine the following questions in a civil court that should be answered based on a preponderance of evidence:
1) Did the authors conduct Post-Selections for [69] using a fitting set, a validation set, a test set or a combination thereof?
2) As the validation error 15.4% is larger than the test error 15.3%, is it more likely that the authors used a test set (or both test and validation sets) for FIG. 3 than not using a test set at all?
3) Did the authors lack due transparency about the Post-Selection stage in [69]?

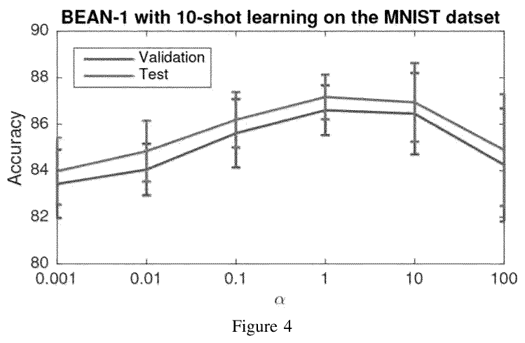

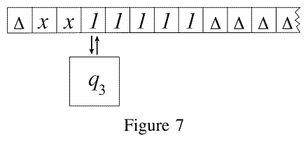

For examples of PSUTS by other authors, see FIG. 4 from [70, FIG. 7], error-backprop consistently results lower validation accuracies than the test accuracies (about 0.5% lower compared to about 0.1% lower in [69]). PSUTS was probably used instead of PSUVS because the test data are better than the validation data, like Krizevsky & Hinton 2017 [69, page 88]. Are they other evidences of using PSUTS instead of PSUVS, similar to [69]? The availability of test sets to the programmers in a project seems to be indeed addictive towards PSUTS, away from PSUVS. The standard deviation around 1% is clashes with our Theorem 5. Our experience with our own experiments with error-backprop training for CNN indicated that the maximum and the minimum values of the distribution of fitting accuracies are drastically different for different random seeds, with fitting accuracies spreading uniformly between 20% and 90%. Section II will discuss why. If Theorem 5 in Section II is correct, the deviation bars seem too small and the 20 runs in FIG. 7 of [70] could be the best 20 among many more random-seeds the programmer has tried. We hope that authors provide the source program.

### K. Implications of PSUTS

Although the set {e_{i,j}|i=1, 2, . . . n; j=1, 2, . . . k} is large, it is necessary to present some key statistical characteristics of its distribution. For example, rank all errors in decreasing order, for each type of errors, fitting, validation and test. Then give the maximum, 75% (in ranked population), 50% (median), 25%, the minimum value, and the standard deviation of these kn values for the fitting errors, validation errors. and test errors, respectively, not just the standard deviation in FIG. 4. Such more complete information of the distribution is critical for the research community to see whether error-backprop can indeed avoid local minima in deep learning as some authors claimed. Furthermore, such information is also important for the authors to show that the luckiest hyper-parameter vector is not just an over fitting to the validation/test set. Unfortunately, none of [23], [76], [24], [25], [27], [66], [29], [31] reported such distribution characteristics other than the minimum value e_{i*,j*}.

Furthermore, such a use of test sets to post-select networks resembles hiring a larger number kn of random test takers and report only the luckiest N(a_{i*}, w_{j*}) after the grading. This practice could hardly be acceptable to any test agencies and any agencies that will use the test scores for admission purpose since this submitted error e_{i*,j*} misleads due to its lack of validation.

The error-backprop training tends to locally fit each network on the fitting set F; while the Post-Selection picks the luckiest network with parameter vector aᵢ, and initial weights w_{j*} that has the best luck on T. If an unobserved data set T′, disjoint with T, T∩T′=0, is observed from the same distribution S, the error rate e_{i*,j*}′ of N(a_{i*}, w_{j*}) is predicted to be significantly higher than e_{i*,j*},

$${e}_{{i}^{*} , {j}^{*}}^{′} ≫ {e}_{{i}^{*} , {j}^{*}} \qquad ( 13 )$$

because Eq. (11) depends on the test set T in the post selection from many networks.

Of course, handling a new test is also challenging for a human student but a human learning involves learning invariant rules. The emergent universal Turing machine in Section III-D is meant to learn such invariant rules as explained in [50], which are more powerful than the (greedy) data-fitting methodology of so called Deep Learning in AI. A Post-Selection is a technically flawed protocol that hides the key weakness of this data-fitting methodology.

PSUTS is tempting especially when test sets are available to the authors of a paper.

Weng 2020 [82], [83] argued that the claims by some public speakers that such misleading errors have approached or even succeeded human performance [68] are controversial, since there are no explicit competition rules that ban test sets to be used for Post-Selections.

### L. Human PSUTS

Instead of writing a search program in machine PSUTS, human PSUTS defined below typically involves less computational resources and programming demands.

Definition 6 (Human PSUTS): After planning experiments or knowing what will be in the fitting set F and test set T, a human post-selects features in networks instead of using a machine to learn such features.

Unfortunately, almost all methods in the symbolic school use human PSUTS because it is always the same human who plans for and design a micro-world and collect the test set T. The key to an acceptable test score lies in how much detail the human designer can plan for what is in the test sets and how much freedom s programmer has in hand picking features.

Poggio et al. [84] and Fukushima et al. [17] explicitly admitted their use of human PSUTS. Li Fei-Fei at al. [19] only vaguely admitted their use of human PSUTS by a vague term “weakly supervised” using an extension of formulation by Pietro Perona that is originally unsupervised. Questions raised towards [19] on PubPeer were not answered by the authors.

To explain why Post-Selections give misleading results, let us derive the following theorem.

Theorem 4 (Post-Selection Illusion): Given any validation error rate eᵥ≥0 and test error rate eₜ≥0, the nearest neighbor classifiers with a distance threshold in Definition 4 satisfies the eᵥ and eₜ, if the computational resources and the time spent on Post-Selections are not bounded.

Proof: For the proof, let us introduce some details. Suppose that there are three data sets, fitting set F, verification set V, and test set T, a desired verification error eᵥ≥0, and a desired test error eₜ≥0, run the following program P(s) that starts from random seed s.
1) Store all data from the fitting set F.
2) For each receptive field (e.g., rectangular) q inside of a cluttered image or a cluttered video x∈V, or x∈T, compute the distance dᵢ=d(q, xᵢ) between receptive field q and each annotated receptive field xᵢ in F for all values of i (each sample in F have multiple annotated receptive field xᵢ's).
3) Produce the class label lⱼ of the nearest neighbor xⱼ that produces the smallest distance: j=argminᵢ{dᵢ}.
4) If dⱼ≤d(s) where d(s) is a threshold depending on random seed s, output the label lⱼ of the nearest neighbor. Otherwise, output a label that is randomly and uniformly sampled from the label set L.

Post-Selection stage: If the measured verification error or the test error is larger than required, do the above procedure P(s) for a new seed s. Repeat until the measured verification error and test error are both not larger than the required eᵥ and eₜ, respectively.

Because the number of seeds to be tried during the Post-Selection is unlimited, there is a finite time at which a lucky seed d(s) will produce the good enough verification error and test error.

Although the waiting time is long, the time is finite because V and T are finite. Let us formally prove this. Suppose l is the number of labels in the output set L and for the set of queries in V and T, there are k outputs that must be guessed. The probability for a single guess to be correct is 1/l due to the uniform sampling in L. The probability for k guesses to be all correct is (1/l)^{k}=1/l^{k} because guesses are independent. For a randomly initialized network to guess less than k cases correct is 1−1/l^{k}, with 1−1/l^{k}<1. The probability for n networks, all of which are not good enough for eᵥ or eₜ is

$$p ( n ) = {( 1 - 1 / {l}^{k} )}^{n} {\to }^{n \to ∞} 0.$$

because 1−1/l^{k}<1. Namely, within a finite time, the search will find one network that satisfies both eᵥ and eₜ.

As we can see from the proof, the smaller the threshold, the more guesses must be made and, thus, typically the longer time one needs to spend during Post-Selections.

Let us imagine that the threshold d(s) gradually increases from zero toward infinity. The nearest neighbor classifier changes from a total-lottery scheme (when d(s)=0) to a traditional nearest neighbor classifier (without label guesses) when all query inputs are beyond the threshold.

Yes, while the test sets are in the possession of authors, the authors could show any superficially impressive validation error rates and test error rates because they used Post-Selections without a limit on resources (to store all data sets and to search for the luckiest network).

Theorem 4 has established that Post-Selections can even produce a perfect classifier that gives a zero validation error and zero test error to mislead us!

The above theorem means any competitions without an explicit limit on storage and time spent on Post-Selections are meaningless, like ImageNet and many other competitions. It is of course time consuming for a program to search for a network whose guessed labels are good enough. An alternative approach is to define an “unknown” label in L and output “unknown” when the distance is larger than the threshold.

Corollary 1 (Misleading AI papers): If a paper trains more than one system, the performance data from the paper are misleading if the paper does not report the number of systems trained in Post-Selections, the amount of computational resources (i.e., the amount of storage, the number of computers, the type of computers, and the network refreshing rates), the amount of waiting time, the fitting errors, the validation errors, and the test errors of all trained systems.

Proof: From Theorem 4, if Post-Selections are allowed, a nearest neighbor classifier with a random distance threshold can satisfy any nonzero validation error and any nonzero testing error using Post-Selections, since the training set, validation set and the test set are all in the possession of the authors.

This corollary is a scientific basis for the author to raise a violation of protocols and a lack of transparency about the Post-Selection stage in almost all machine learning papers appeared in Nature, Science, Communication of ACM [85] and other publication venues since around 2015. Since all the fitting sets, validation sets and test sets are in the possession of the authors, many papers have claimed misleading results using a flawed protocol.

### II. Why Error-Backprop Needs Post-Selections

This section discusses a global view, which is new as far as the author is aware, about why error-backprop learning in neural networks suffers from local minima even in an easier batch-learning mode.

Since error-backprop does not perform well for incremental learning mode as we can see why also from the following discussion, we will concentrate on batch learning mode. Namely, we let the network “see” the entire fitting set F for each network update.

Let us first consider a well-known neuronal model that is applicable to many CNNs. Suppose a post-synaptic neuron with activation zⱼ is connected to its pre-synaptic neurons yᵢ, i=1, 2, . . . , n, through

$$ϕ ( {\sum }_{i = 1}^{n} {w}_{ij} {y}_{i} ) = {z}_{j} \qquad ( 14 )$$

where

$$ϕ ( y ) = \frac{1}{1 + {e}^{- y}}$$

is the logistic function. The gradient of zⱼ with respect to weight vector wⱼ=(w_{1,j}, w_{2,j}, . . . , w_{n,j}) is

η(y₁,y₂, . . . ,yₙ) [symbol] ηy

where η is the partial derivative of ϕ(y). Thus, according to gradient direction, the change of the weight vector wⱼ is along the direction of pre-synaptic input vector y. If the error is negative, zⱼ should increase. Then the weight vector should be incremented by

$${w}_{j} ← {w}_{j} + {w}_{2} y \qquad ( 15 )$$

where w₂ is the learning rate. We use the w₂ to relate better the optimal Hebbian learning, called LCA, used by DN in Section III. At this point, the following theorem is in order.

Theorem 5 (Lacks of error-backprop): Error-backprop lacks (1) energy conservation, (2) an age-dependent learning rate, and (3) competition based role-determination.

Proof: Proof of (1): If pre-synaptic input vectors {y} are similar, multiple applications of Eq. (15) add many terms of {w₂y} into the weight vector wⱼ causing it to explode, which means a lack of energy conversation. Proof of (2): w₂ is typically tuned by an ad hoc way, such as a handpicked small value turned by a term called momentum, instead of being automatically determined in Maximum Likelihood optimality (ML-optimality) by neuronal firing age to be discussed in Section III. Proof of (3): Suppose neuron zⱼ is in a hidden area of the network hierarchy. This neuron zⱼ updates its pre-synaptic weight using Eq. (15) regardless zⱼ is role-responsible or not for the current network error. Likewise, looking upstream, there is also a lack of role-determination in the gradient-based update for pre-synaptic neurons y₁, y₂, . . . , yₙ, all of which must update their own weights using their own gradients. Namely, there is no competition-based role-determination in error-backprop.

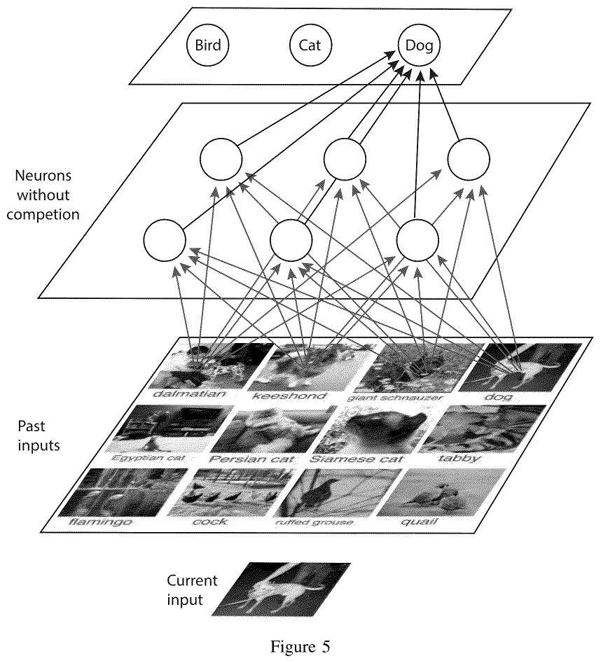

The meaning (3) of Theorem 5 are illustrated by FIG. 5. The problem is worse with a deeper hierarchy. CNNs do not have a competition mechanism in any layers. Complete connections initialized with random weights are provided for all consecutive areas (also called layers), from input area all the way to the output area. If the zⱼ neuron is in the output motor area and each output neuron is assigned a single class label, the role of zⱼ (“dog” in the figure) is determined by human supervised label “dog”. However, let us assume instead that zⱼ is in a hidden area, not responsible for the “dog” class. zⱼ still updates its input weights using the gradient. Likewise, the pre-synaptic area Y, is characterized by its label “neurons without competition”. The hidden neurons in this area do not have a competition mechanism which would, like in LCA [48], allow a small proportion of neurons to win the competition and fire so that they automatically take the roles that they happened to compete well. This analysis leads us to the following theorem.

It is important to note that the key point is global role-determination through global competition instead of local inhibition (such as pooling for resolution-reduction [16]) or attention because they do not enable role-determination among neurons in a global way.

Theorem 6 (Random roles in error-backprop): A set of random initial weights in a network assigns random roles to all hidden neurons, from which a local minimal point based on error-backprop learning inherits this particular random-role assignment. Which neurons in each hidden area take a role does not matter, but how hidden neurons share a set of roles in each hidden area does matter in the final fitting error, validation error, and test error after error-backprop.

Proof: Without loss of generality, suppose a maximum in the output neuron means a positive classification and weights take positive and negative values. Then, a positive weight to an output neuron zⱼ from a hidden neuron yᵢ means an excitatory role of yᵢ to zᵢ and a negative weight means an inhibitory role. A zero weight means an irrelevant role. The gradient vector computed in Eq. (15) means such excitatory-inhibitory input patterns from pre-synaptic neurons are added through iterative error-backprop procedures. Because of the complete connections and an identical neuronal type, where a hidden neuron is located in the FIG. 5 does not matter, but each input image must have a sufficient number of hidden neurons in every hidden area to excite for its signals to reach the corresponding output neuron. The initial role assignment patterns in initial weights do matter for the final the fitting error rate, the validation error rate, and the test error rate, because gradient updates are local and inherited such initial roles.

Theorem 7 (Percentage luck of error-backprop): Suppose a CNN has l>1 areas, A₀, A₁, . . . , Aₗ, connected by a cascade or a variation thereof. A₀ takes input frames {x∈X} and Aₗ is the output area for classification. Suppose an area has a total of m hidden neurons that share a common receptive field R in A₀. Consider a given input frame x. Let the percentage of the m hidden neurons that do not fire among all neurons in the same area with the same receptive field be denoted as p(x). Then, the error-backprop depends on the average p̅=E_{x∈X}{p(x)} to be a reasonably small value, called the percentage luck.

Proof: To guide the proof, we should mention that DNs use top-k competition so that each receptive field in each area has only k neurons that fires, where k is small, e.g., top-1, for each receptive field R. Suppose a receptive field R represents a neuronal column that has n neurons. A neuronal area at level l is denoted as Aₗ. Every receptive field image x∈X=A₀ is concrete by which we means that its neurons are only pixels {x} of a concrete example of a class C with p̅(x)=P(x fires)≈50% (e.g., 50% back and 50% white). Each neuron z in area Aₗ is abstract by which we means that it fires means an abstract class C that x belongs to, with p̅(z) being small corresponds to top-1 among n neurons. Then, it is necessary for the CNN to convert the most concrete representation of pixels in A₀ to more abstract representations in Aₗ, l>0 with a low p̅(z). For example, in FIG. 5, we have l=2 and there is no completion in the hidden area A₁. Then error-backprop depends on that each neuron in A₂ has only a relatively smaller percentage among n=6 neurons in A₁ that are positive, i.e., as the features of its particular class. The requirement of being a small percentage is due to the need for other non-firing neurons to deal with many other patterns in the same receptive field.

As we can expect, such a low percentage condition is rarely satisfied by a random weight vector. The more random weight vectors one uses, the better chance to hit the luck.

From Theorems 5 through 7 and their proofs, we can see that the luck of role assignment is a critical flaw of error-backprop, and so are the system parameters and the simple-minded regularization of the learning rate. Because of these key reasons, PSUTS plays a critical role to select the luckiest network from many unlucky ones after error-backprop. The more networks have trained by error-backprop, the more likely the luckiest one has a good role-assignment to start with.

There has been no lack of papers that claim to justify error-backprop does not over fit, e.g., variance based stochastic gradient decent [86], saddle-free deep network [87], drop out [88], implicit regularization during gradient flow [89]. There have been other papers [90], [91] that weakly discussed the local minima issue. The main weakness is that these papers all address only local issues of neural networks and did not mention Post-Selections. There have been no papers, as far as the author is aware of, that have correctly established the freedom from local minima with gradient-based learning techniques for neural networks.

In contrast, the optimality work here is a global method for a single trained network without Post-Selections. The theory here addresses, the global role-assignment problem of random weights that no local mechanisms can deal with. This seems to be why PSUTS is necessary by error-backprop, but PSUTS is controversially fraudulent in terms of protocol-test sets are meant to test a reported system, not supposed to be used to decide which network to report from many.

From the above discussion, we can obtain a more general observation: Any locally greedy method is always a local minimum, due to a lack of competitions combined with the restrictions of the Four Learning Conditions. This more general observation has a great importance to not only neural networks, but also to other learning modes, including reinforcement, swarm, reservoir, and evolutionary learning modes.

The following Post-Selection free method is restricted by the Four Learning Conditions.

### III. Post-Selection Free Method

Apparently, a brain does not use Post-Selection at al, whether PSUVS or PSUTS, because every human child must develop in a human environment to make his living. He should not be covered up and not reported, regardless how well or bad he performs. Cresceptron in the 1990s [43], [44], [16], [45], [46] and later DN [49], [62], [51], [52] were inspired by the interactive mode that brains learn though lifetime. In other words, Cresceptron and DN do not need Post-Selections. Furthermore, every DN must be ML-optimal given the same Four Learning Conditions.

### A. New AI Metrics: Developmental Errors

In contrast to Post-Selections likely used by [21], [14], [19], [84], [23], [76], [24], [25], [27], [66], [29], [31] including probably AlphaGo [26], AlphaGo Zero [28], AlphaZero [65], AlphaFold [30] and MuZero [67] and many others, we define and reported developmental errors that includes all errors occurred through lifetime of each learning network:

Definition 7 (Developmental error): A Developmental Network is denoted as N=(X, Y, W_{y}, Z, W_{z}, A) with sensory area X, skull closed hidden area Y and its weight space W_{y}, and motor area Z and its weight space W_{z}, and the space of architecture parameters A, where X, Y, and Z also denote the spaces of responses of X, Y and Z areas, respectively. The space of architecture parameters A includes all remaining parameters and memory of the network, other than neuronal weighs, such as ages of neurons (for learning rates), neuronal patterning parameters (location and receptive fields adapted by synaptic maintenance), neuronal types (for initial connection absences among areas), and neuronal growth rates (for speed of mitosis). It runs through lifetime by sampling at discrete time indices as N(t), t=0, 1, 2, . . . . Start at inception t=0 with supervised sensory input x₀∈X(0), initial state z₀∈Z(0), randomly initialized weigh vector y₀∈Y(0), initial architecture a₀∈A(0). At each time t, t=1, 2, . . . , the network N(t) recursively and incrementally updates:

$$( {x}_{t} , {y}_{t} , {z}_{t} , {a}_{t} ) = f ( {x}_{t - 1} , {y}_{t - 1} , {z}_{t - 1} , {a}_{t - 1} ) \qquad ( 16 )$$

where ƒ is the Developmental Program (DP) of N. If zₜ∈Z(t) is supervised by the teacher, the network complies and the error eₜ is recorded, but if the supervised motor vector has error, the error should be treated as teacher's. Otherwise, the learner is not motor-supervised and N(t) generates a motor vector zₜ and is observed by the teacher and its vector difference from the desired z* is recorded as error eₜ. The lifetime average error for each motor concept or component, from time 0 up to time t is defined as

$$\overline{e} ( t ) {=}^{Δ} \frac{1}{t} {\sum }_{i = 0}^{t} {e}_{i} , \qquad ( 17 )$$

which is computed incrementally in terms of average developmental error ē(t):

$$\overline{e} ( t ) = \frac{t - 1}{t} \overline{e} ( t - 1 ) + \frac{1}{t} {e}_{t} . \qquad ( 18 )$$

Namely, all errors across a lifetime, at every time instance, are caught by the developmental error. In order to reach a small error, a low final error rate that a batch learning method tries to reach is not sufficient. Instead, the network must learn as fast as possible and avoid errors as much as possible at every time instance t. This is indeed important since earlier performance will shape later learning.

It is important to note that developmental error is recursively weighted by “reinforcement value” as explained in [47], [42], not an equal average over time. For example, driving across a red light occurs only few times in a life, but has a high actual serotonin punishment and recalled cognitive punishment [47], [42] through communicative learning (i.e., verbal communications without experiencing a death and without any time-discount like in Q-learning, but hearing horrible stories and trusted people warn against it). A DN further models unified scaffolding [77]: adults avoid children behaviors.

An optimal network that gives the lowest possible developmental error, among all possible networks under the same Four Learning Conditions, must be optimal at every time instance t throughout its life. DN is one such network. Post-Selections are useless among neural networks that give the smallest developmental error under the same Four Learning Conditions, because the maximum-likelihood optimality should give equivalent networks of the same developmental error.

However, in practice, the learning experience in the Four Learning Conditions is unlikely the same among different networks, because each physical robot that runs a network at least occupies distinct physical locations in the real world. For example, if two physical robot in the same family fight for a toy, the winner gains a winner experience and the loser may acquire a loser mentality. In other words, even if the parents of two boys are not biased toward any boys, the competition among the boys results in different learning experiences.

The developmental error is important. If a competition is based on developmental errors (such as during AIML Contests [73]), the winner is unlikely be one that uses a brute force method but has an excessive amount of computational resources and manpower. ImageNet competitions [68] are flowed also in this sense.

Although not formally defined as developmental errors, Cresceptron [16] and Developmental Networks [41], [92], [93] reported developmental errors.

Namely, the developmental error, unless stated otherwise for a particular time period, is the average lifetime error from inception. To report more detailed information about the process of developmental errors {eₜ|t≥0}, statistics other than the mean (average) can be utilized, such as the minimum, 25%, 50% (median), 75%, the maximum, and the standard deviation.

For more a specific time period, such as the period from age t₁ to age t₂, the average error is denoted as ē[t₁:t₂]. Therefore, ē(t) is a short notation for ē[0:t].

Because Cresceptron and DN have a dynamic number of neurons up to a system memory limit, each new context

$${c}_{t} {=}^{Δ} ( {x}_{t} , {y}_{t} , {z}_{t} ) \qquad ( 19 )$$

may be significantly different from the nearest matched learned weight vectors of all hidden neurons. If that happens and there are still new hidden neuron that have not fired, a free-state neuron that happens to be the best match is spawned that perfectly memorizes this new context regardless its randomly initialized weights. When all the free neurons have fired at least once, the DN will update the top-k matched neurons optimally in the sense of maximum likelihood (ML), as proven for DN-1 by [41] and for DN-2 by [92], as we will discuss below.

Note that a developmental system has two input areas from the environment, sensory X and motor Z. That is, motor Z is supervisable by the world (including teachers) but not often. Since there is hardly any sensory input x∈X that exactly duplicates at two different time indices, almost all sensory inputs from X are sensory-disjoint. During motor-supervised learning, if the teacher supervises its motor area Z and the learner complies. Since a teacher can make an error, the motor-error that the teacher made is also recorded as the developmental error of the motor of the learner but due to the teacher.

### B. Neuronal Competitions

As discussed above, error-backprop learning is without neuronal competitions. The main purpose of competition is to automatically assign roles to hidden neurons. Below, we consider two kinds of Convolution Neural Networks (CNNs), sensory networks and sensorimotor networks. A sensory network is feedforward, from sensor to motor, in computation flow and therefore is simpler and easier to understand. A sensorimotor network takes both sensor and motor as inputs and is highly recurrent and therefore more powerful.

1) Sensory networks: Let us first consider the case of feed-forward networks as illustrated in FIG. 6. FIG. 6(a) shows a situation where the number of samples in X is larger than the number of hidden neurons, which is typical. Otherwise, if there are sufficient hidden neurons, each hidden neuron can simply memorize a single sample x∈X. FIG. 6 illustrates how competition automatically assigns roles among hidden neurons without a central controller: The case for automatically construct a mapping ƒ: X [symbol] L. (a) The number of samples in X is larger than the number of hidden neurons such that each hidden neuron must win-and-fire for multiple inputs. (b) Error-backprop from the “dog” motor neuron asks some hidden neurons to help but the current input feature is not their job. Thus, error-backprop messes up with the role assignment guessed by the random initial weights. The same ideas are true for a deeper hierarchy.

This means that the total number of hidden neurons must be shared through incremental learning, where each sample image-label pair (x, l)∈X×L arrives incrementally through time, t=0, 1, 2, . . . . This is the case with Cresceptron (and some other networks) which conducts incremental learning by dealing with image-label pairs one at a time and update the network incrementally.

Every layer in Cresceptron consists of a image-feature kernel, which is very different from those in DN where each hidden neuron represents a sensorimotor feature to be discussed later. By image-feature, we mean that each hidden neuron is centered at an image pixel. Competitions take place within the column for a receptive field centered at each pixel at the resolution of the layer. The resolution reduces from lower layer to higher layer through was called resolution reduction (also called drop-out).

The competition in incremental learning is represented by incrementally assigning a new neuronal plane (convolution plane) where the new kernel memorizes the new input pattern if the best matched neuron in a column does not match sufficiently well. Suppose images x∈X arrives sequentially, the top-1 competition in the hidden layer in FIG. 6(a) enables each hidden neuron to respond to multiple features, indicated by the typically multiple upward arrows, one from each image, pointing to a hidden neuron. This amounts to incremental clustering based on top-k competition. The weight vector of each hidden Y neuron corresponds to a cluster in the X space. In FIG. 6(a), k=1 for top-k competition in Y.

Likewise, suppose top-1 competition in the next higher layer, Y, namely each time only one Y neuron fires at 1 and all other Y neurons do not fire, resulting the connection patterns from the second layer Y to the next higher layer Z. In the output layer Z, top-1 competition takes place but a human teacher can supervise the pattern.

The Candid Covariance-free Incremental (CCI) Lobe Component Analysis (LCA) in Weng 2009 [48] proved that such automatic assignment of roles through competition results in a dually optimal neuronal layer, optimal spatially and optimal temporally. Optimal spatially means the CCI LCA incrementally computes the first principal component features of the receptive field. Optimal temporally means that the principal component vector has the least expected distance to its target the optimal estimator in the sense of minimum variance to the true LCA vector.

Intuitively, regardless what random weights each hidden neuron starts with, as soon as it wins to fire for the first time, its firing age a=1. Its random weight vector is multiplied by the zero retention rate w₁=1−1/a=0 and this learning rate w₂=1/a=1 so that the new weight vector becomes the first input rx with r=1 for the firing winner.

$$v ← ( 1 - \frac{1}{a} ) v + \frac{1}{a} rx . \qquad ( 20 )$$

It has been proven that the above expression incrementally computes the first principal component as v. The learning rate w₂=1/a is the optimal and age-dependent learning rate. CCI LCA is a framework for dually optimal Hebbian learning. The property “candid” corresponds to the property that sum of the learning rate w₂=1/a and the retention rate w₁=1−1/a is always 1 to keep the “energy” of response r weighted input x unchanged (e.g., not to explode or vanish). This dually optimality resolves the three problems in Theorem 5.

There have been many ideas about “adaptive learning rate” (e.g., adaptive momentum), but they all do not have the dual-optimality of LCA that requires the age-dependent learning rate. For more details and a mathematical derivation, see [48].

FIG. 6(b) shows how the three neurons in the Z area updates their weights so that the weight from the second area to the third area become the probability of firing, conditioned on the firing of the post-synaptic neuron in area Z (Dog, Cat, Bird, etc.). The CCI LAC guarantees that the sum of weights for each Z neuron sum to 1. This automatic role assignment optimally solves the random role problem of error-backprop in Theorem 6.

However, optimal network for incrementally constructing a mapping ƒ: X [symbol] L is too restricted, since ƒ: X [symbol] L is only what brains can do, but not all brains can do. For the latter, we must address sensorimotor networks.

2) Sensorimotor networks: The main reason that Marvin Minsky [5] complained that neural network is scruffy was because conventional neural networks lacked not only the optimality described above for sensory networks, but also lacked the Emergent Universal Turing Machines (EUTM) that is ML-optimal we now discuss below.

First, each neuron in the brain not only corresponds to a sensory feature as illustrated in FIG. 6, but also a sensorimotor feature. By sensorimotor feature, we mean that the firing of each hidden neuron in FIG. 6 is determined not just by the current image σ represented by a sensory vector x∈X, but also the state q represented by a motor vector z∈Z. It is well known that a biological brain contains not only bottom-up inputs from x∈X but also top-down inputs from z∈Z. In summary, each hidden neuron represents a sensorimotor feature in a complex brain-like network.

### C. FA as Sensorimotor Mapping

This sensorimotor feature is easier to understand if we use the conventional symbols for (symbolic) automata. Let us borrow the idea of Finite Automaton (FA). In an FA, transitions are represented by function δ: Q×Σ [symbol] Q, where Σ is the set of input symbols and Q the set of states. Each transition is represented by

$$( q , σ ) {\to }^{f} {q}^{′}$$

a) AFA as a control of any Turing machine: Weng 2015 [41] extended the definition the FA so that it outputs its state so the resulting FA becomes an Agent FA (AFA). Further, Weng 2015 [41] extended the action q to the machinery of Turing machine (see FIG. 7) so that action q includes output symbol to the Turing tape and the head motion of the read-write head of a Turing machine. With this extension, Weng 2015 [41] proved that the control of any Turing machine is an AFA, a surprising result.

Here q∈Q is the top-down motor input to a sensorimotor feature neuron; a is the bottom-up sensory input to the same neuron. If 6 has n transitions, n hidden neurons in the Y area are sufficient to memorize all the transitions that is observed sequentially, one transition at a time.

We should not use symbols like a and q, but instead sensory vectors x∈X and motor vectors z∈Z that are emergent as discussed above. At discrete time t=0, 1, 2, . . . , we use the hidden neurons in the Y area to incrementally learn the transitions:

$$[ \begin{matrix}Z ( 0 ) \\ Y ( 0 ) \\ X ( 0 )\end{matrix} ] \to [ \begin{matrix}Z ( 1 ) \\ Y ( 1 ) \\ X ( 1 )\end{matrix} ] \to [ \begin{matrix}Z ( 2 ) \\ Y ( 2 ) \\ X ( 2 )\end{matrix} ] \to … \qquad ( 21 )$$

where → means neurons on the right use the input neurons on the right and compete to fire as explained below without iterations. Namely, by unfolding time, the spatially recurrent DN becomes non-recurrent in a time-unfolded and time-sampled DN. With LCA update, [41] proved that such a DN is ML-optimal and has a constant complexity for each update O(1) with a large constant, suited for real-time computation with a large memory and many neurons.

### D. DN as a ML-Optimal of Emergent Universal Super-Turing Machine

The traditional Turing Machine (TM) is a human handcrafted machine, as illustrated in FIG. 7.

A Universal TM (UTM) s still a TM, but its tape contains two parts, a user supplied program and the data that the program is applied to. The transition function of the UTM is designed to simulate any program encoded in the form of transition of a TM and to apply the program on the data on the tape and finally to place the output of the program on the data onto the tape.

A UTM is a model of the current general-purpose computers because the user can write any program on any set of appropriate data for the UTM to carry out. Because a DN is an ML-optimal emergent FA, Weng 2015 [41] extended a symbolic Turing machine to a super Turing machine by (1) extending the tape to the real world, (2) the input symbols to vectors from sensors, (3) the output symbols to vector output from effectors, and (3) the head motion to any action from the agent. Thus, DN ML-optimally learns any TM, including UTM, directly from the physical world. The programs on the tape are learned by the Super UTM incrementally from the real world across its lifetime!

### E. DN as a ML-Optimal Learning Engine for APFGP and Conscious Learning

Because DN is an ML-optimal learning engine for any TM, including UTM, DN ML-optimally learns any UTM from the physical world, conditioned on those in Definition 2. This means that a DN ML-optimally learns to Autonomous Programming for General Purposes (APFGP) [51], [94]. Based on the capability of APFGP, Weng 2020 argued that APFGP is a characterization of conscious machines [52] that boots its skill of consciousness through conscious learning—being (partially) conscious while learning across lifetime. Hopefully, APFGP is a clearer and more precise characterization for conscious machines and animals, assuming that we allow a conscious machine to develop its degree of consciousness from infancy.

In the following, we list the DN algorithm so that we can understand APFGP is not a vague idea and how APFGP by DN avoids Post-Selections.

### F. DN-2 Algorithm

Let us go through the DN-2 algorithm here so that we can see that DN is fully detail in computer implementation.

DN-2 is the latest general-purpose learning engine in the DN family. In DN-1, the allocation of neurons in each subarea of the hidden Y area is handcrafted by the designer. In DN-2, several biology-inspired mechanisms are added to automatically allocate neuronal resources and generate a dynamic and fluid hierarchy of internal representations during learning, relieving the human designer from handcrafting a concept hierarchy, beyond the rigid hierarchy in deep learning [43], [44], [16], [45], [46], [19], [84], [23], [76], [24], [25], [27], [66], [29], [31]. Namely, a DN-2 starts with simple internal representations which gradually grow to be rich and deep supported by early representations as a “brain stem”, but it is still ML-optimal conditioned on those in Definition 2.

Areas from low to high: X: sensory; Y hidden (internal); Z: motor. From low to high: bottom-up. From high to low: top-down. From one area to the same area: lateral. X does not link with Z directly.

Input areas: X and Z; Output areas: Z; Hidden area: Y, fully closed from t=0.
1) At time t=0, inception. Initialize the X, Y and Z areas. x∈X takes the first image. Set every Y neuron with random weights, zero firing age, and zero response y(0). Set the total number of Y neurons to be n_{Y}. A boundary c_{Y} indicates the number of active neurons (c_{Y}≤n_{Y}). Set the Z area and its memory part M_{Z} similarly, but all concept zones take none vectors if the learner has no prenatally learned inborn “reflexes”.
2) For time t=1, 2, . . . , repeat the following steps forever (executing steps 2a, 2b in parallel, before step 2c):
   a) All Y neurons compute in parallel:

$$( {y}^{′} , {M}_{Y}^{′} ) = {f}_{Y} ( {c}_{Y} , {M}_{Y} ) \qquad ( 22 )$$

where context c_{Y}=(x, y, z), M_{A} denotes the memory of area A including weights and neuronal firing ages, and ƒ_{Y} is the Y area function using LCA [47], [48]. If the best active Y neurons do not match the input vector well, area Y transfers new neurons to active and increment the boundary c_{Y}.
b) Supervise z′ if the teacher likes. Otherwise, Z neurons compute the response vector z and update memory M_{Z}′ in parallel:

$$( {z}^{′} , {M}_{Z}^{′} ) = {f}_{Z} ( {c}_{Y} , {M}_{Z} ) \qquad ( 23 )$$

where ƒ_{Z} is the Z area function using LCA [47], [48] and c_{Z}=(y, z).
c) Replace asynchronously: (y, M_{Y}, z, M_{Z})←(y′, M_{Y}′, z′, M_{Z}′). Supervise input x.

The area function ƒ_{Y} in Eq. (22) and area function ƒ_{Z} in Eq. (23) include two parts: (1) The computation of response vectors y′ and z′, respectively; (2) The maintenance of memory M_{Y}′ and M_{Z}′ for Y area and Z area, respectively.

In a DN-1, each neuron does not have its own competition zone. All neurons in an area share the same competition zone. A neuron files if and only if its pre-action potential is at the top-k among the pre-action potentials of its competing neurons.

In a DN-2, each neuron has its own competition zone, so that the neuron files if and only if its pre-action potential is at the top-k among the pre-action potentials of its own competing neurons.

Regardless of DN-1 or DN-2, the freedom from Post-Selection discuss below applies. The ML-optimality of DN-1 and DN-2 is rooted in the optimality of LCA and extends to the entire network and entire lifetime.

### G. Maximum Likelihood Needs No Post-Selections

Given the Four Learning Conditions, at each time t, t=1, 2, . . . , a DN incrementally computes the ML-estimator of its parameters at each time t that minimizes the developmental error without doing any iterations.

Let us first review the maximum likelihood estimator for a batch data. Let x be the observed data and ƒ_{θ}(x, z) is the probability density function that depends on a vector θ of parameters, there θ(t)=(w_{y}, w_{z}, a) where some parameters of the architecture parameter vector a are hand-initialized such as the receptive fields. The maximum estimator for θ corresponds to the θ that maximizes the probability density. Regardless z is imposed, z is part of the parameters to be computed in a closed-form as a self-generated version:

$$( {θ}^{*} , {y}^{*} , {z}^{*} ) = arg {max}_{( θ , y , z )} {f}_{θ} ( x , z ) . \qquad ( 24 )$$

Since the above lifetime estimator is incremental, at each time t, the previous state zₜ₋₁* is self-generated or supervised, and the observation is xₜ₋₁. The incremental ML-estimator for θₜ* is computed in a closed-form by the incremental version of Eq. (24) where ƒ uses context cₜ₋₁=(xₜ₋₁, yₜ₋₁, zₜ₋₁):

$$( {θ}_{t}^{*} , {y}_{t}^{*} , {z}_{t}^{*} ) = arg {max}_{( {θ}_{t} , {y}_{t} , {z}_{t} )} {f}_{{θ}_{t}} ( {x}_{t - 1} , {y}_{t - 1}^{*} , {z}_{t - 1}^{*} ) . \qquad ( 25 )$$

The DN computes the above expression for each time t in a closed form without conducting any iterations [41], [92].

How about initial weights? Inside θ, the weights of the DN are initialized randomly at t=0. There are k+1 initial neurons in the Y area, and V={\dot{v}ᵢ|i=1, 2, . . . , k+1} is the current synaptic vectors in Y. Whenever the network takes an input p, compute the pre-responses in Y. If the top-1 winner in Y has a pre-response lower than almost perfect match m(t) discussed below, activate a free neuron to fire. Eq. (20) showed that the initial weights of this free neuron is multiplied by a zero and therefore do not affect its updated weights.

Weng [41] proved that DN-1 computes the ML-estimator of all observations from the sensory space X and motor space Z using a large constant time complexity for each time t. Although DN learns incrementally, such a DN is error-free for learning any complex Turing machines, including any universal Turing machines. Weng [92] did the same for DN-2.

### H. How DN Avoids Post-Selections but is Further ML-Optimal

Since weights are initialized randomly, how does a DN result in an equivalent network regardless the random seed? There are k+1 initial neurons in the Y area, and V={\dot{v}ᵢ|i=1, 2, . . . , k+1} is the current synaptic vectors in Y. Whenever the network takes an input p, every Y neuron computes the pre-response. If the top-1 winner in Y has a pre-response lower than almost perfect match m(t), activate a free neuron to fire. The almost perfect match m(t) is defined as follows:

$$m ( t ) = ( 1 - δ ) ( 1 - {e}^{- t / {t}_{1}} ) \qquad ( 26 )$$

where δ is the bound of machine round-off errors, and t₁ the childhood length.

Using a mathematical induction procedure, Weng [41] proved that DN-1 computes the ML-estimator of all observations from (x, y, z) using a large constant time complexity for each time t. Weng et al. 2018 [92] proved the ML-optimality for DN-2. Since the number of transition of any Turing machine is finite, when the DN learns a Turing machine, a finite number of hidden Y neurons is sufficient for the DN to incrementally memorize exactly all the transitions observed from the Turing machine. In other words, although DN learns incrementally, such a DN is error-free for learning any complex Turing machines, including any universal Turing machines.

If the DN runs in the real world, any finite size DN is not error-free soon after inception since the number of observations from the real world is virtually unbounded, although each life is time bounded. Namely, the amount of data from the real world is so large that any practically large DN will eventually run out of free neurons that have not fired yet. From that point on, the DN is no longer guaranteed to be error-free, although could be sometimes error-free, but is still ML-optimal inside the skull conditioned on those in Definition 2. In other words, in the sense of ML, the DN is free of local minima inside the skull. That is why only one DN is sufficient for each life and the DN avoids Post-Selections. However, because the four conditions in Definition 2, a DN is not be optimal unconditionally either. For example, a better designed teaching schedule or a more appropriate physical environment may enable a DN to learn and discover rules faster and better.

I. Comparison with HMM

It is important to compare the traditional Hidden Markov Model (HMM) [95] with the ML-optimal DN. (1) The former does not have any internal representations other than the symbol based probabilities; the latter self-generates internal representations to generalize based on internal-representation based probabilities (e.g., weights). (2) The former uses batch learning but the latter uses incremental learning. (3) States in the former are symbolic, static, only partially observable for HMM, and not teachable but those in the latter are emergent, observable and directly teachable if the teacher like. (4) The former requires a batch clustering method (e.g., k-mean clustering) to initialize a static set of symbolic states, but the states/actions in the latter are incrementally taught or autonomously generated and tried. (5) Clusters of states in the former are not supported by a statistical optimality and the probability is only for state estimates but those in the latter are ML-optimal throughout the lifetime of learning, not in states/actions that the learner must produce and do not have a freedom for, but for the internal representations that the learner does have a high degree of freedom for. (6) Due to the need to compute internal representations, the amount of computations in the latter is often higher than the former but the computational complexity is linear in time with a large constant (the number of weights of all available neurons).

### J. A Post-Selection Free Procedure

Motivated by the above discussion and guided by the details of the method above, the inventor provides a procedure that is free from post-selection, as an example of the method.
1) A robotic learning machine has a number of sensors, a number of effectors, a robot controller running on a computer with a non-transitory computer-readable memory.
2) The computer runs a Developmental Program which regulates the development of a Developmental Network that also runs inside the computer.
3) The Developmental Network has three areas, the sensory area X connected to sensors, the motor area Z connected to and from effectors, and the hidden area Y bidirectionally connected to the sensory area X and bidirectionally connected to the motor area.
4) The Developmental Network is initialized by handcrafted hyper parameters such as growth hormone schedule, the number of available neurons, a zero age for all neurons, and random weights for all neurons.
5) Set the initial value of the developmental error to zero.
6) The machine as an age, as the number of time frames it has run from its conception. The age is unlimited, as the machine works while awake and will never die. The memory of the machine is limited by the physical storage, which can be expanded during the life. The sensors, effectors, computer hardware and other physical components can be expanded or replaced during the lifetime.
7) At age zero, the machine conceives its artificial life.
8) Prenatal development: The machine has a prenatal development stage. During the prenatal development, the machine learns incrementally from a sequence of sensorimotor pairs fed from a programmer to develop its innate sensorimotor behaviors.
   a) At each frame time, feed the Development Network with the next sensorimotor pair.
   b) Incrementally update the Developmental Network by one time frame.
   c) Incrementally update the developmental error and report the error.
   d) Advance the age by one frame.
   e) The machine has a birth time. If the birth time has not been reached, repeat the above steps from a) through e). Otherwise, do the following.
9) Birth: After the birth time, the machine conducts postnatal development by applying its sensors and effectors.
   a) At each frame time, the Development Network generates a motor vector and the sensors generate a sensory vector.
   b) The machine has a number of teachers as part of the extra-body environment, but the hidden area of the Developmental Network is off-limit to the teachers during a normal life. A teacher occasionally imposes a number of effectors using a joystick for motor-imposed training, but the effectors should be mostly free.
   c) Incrementally update the Developmental Network by one time frame.
   d) Incrementally update the developmental error and report the error.
   e) Advance the age by one frame
   f) The learning machine has a sleep mode. If the sleep mode is on provided from the joystick, enter sleep. Otherwise repeat the above steps from a) through f).

At each age, the Developmental Network is optimal in the sense of maximum likelihood (ML), conditioned on the Three Learning Conditions. Although the ML-optimality is different from minimizing the developmental error, the developmental error from the conception time up to each age is an externally measured average performance of motor actions generated by the ML-optimal Developmental Network.

Each network is not subject to post-selection or discarded as not used. At every age, the learning machine performs while learning concurrently.

### IV. Experiments

### A. Vision, Audition and Natural Languages

The recent experimental results of DN work here include (1) vision that includes simultaneous recognition and detection and vision-guided navigation on MSU campus walkways [96], (2) audition to learn phonemes with a simulated cochlea and the corresponding behaviors [97], (3) acquisition of English and French in an interactive bilingual environment [98], and (4) exploration in a simulated maze environment with autonomous learning for vision, path cost, planning, and selection of the least-cost plan, where all such emergent actions are either covert (thoughts) or overt (acts) [99]. The same network was used to learn these four very different tasks and task environments while each task embeds the ML-optimality of the network, under the Four Learning Conditions.

B. Error-Backprop vs. ML-Optimal DN

To show the effects of the absence of ML-optimality in CNN vs. the ML-optimality of DN, FIG. 8 shows the errors of the luckiest Convolutional Neural Network (CNN) trained by a batch error-backprop method and the errors of a DN trained incrementally. “Recog” and “Full” means teach where-what rules. Otherwise, data-fitting only. As we understand, batch learning should not be compared with an incremental learning method, because it is not a comparison on an equal footing. However, FIG. 8 shows that DN does a harder (incremental) work drastically better than CNN does an easier (batch) work. The task is real-world vision-guided navigation on the campus of Michigan State University. Because the DN is optimal in maximum-likelihood, it reaches the minimum error as soon as it has gone through the data set T once (one epoch). Later epochs correspond to reviews of the same data set T. According to the maximum-likelihood principle, the optimal estimate of the neuronal weights should not change but the ages of the neurons continue to advance. In contract, the luckiest error-backprop trained CNN chosen from several random seeds need many epochs to reduce its errors and only very slowly. At the end of 500th epoch, the error of the luckiest CNN trained by error-backprop is still considerably higher than the full DN. Furthermore, as show in FIG. 8, teaching invariant concepts, i.e., abstraction in Theorem 2, are use for reducing the optimal errors. For more detail, the reader is referred to [71].

### C. AIML Contests

In the AIML Contest 2016, all teams are required to use a single learning engine to learn three sensory modalities, vision, audition, and bilingual natural languages acquisition, while the engine learns in “lifetime”. Although all the teams are free to choose any existing learning engines such as DN, tensor-flow or other engines, all the teams chose DN engine (open source). The supplied simulated sequential data (yes, subject to the “big data” flaw) are as follows. When we let the x be the image at each time instance and z be the pattern of landmark location-and-type and action of navigation, the DN became a vision-guided navigation machine. When we let x be the frame of firing pattern of hair cells in cochlea at each time instance and z be the dense states/contexts and the sparse type of sounds, the DN became a auditory-recognizer machine. When we let x be a time frame of vector of word (either English or French) and z be the language kind (neutral, English, and French) and meaning of each sentence context, the DN became a bilingual language learner and recognizer. Thus, the AIML Contest appeared to be the first contest that independently demonstrated task-nonspecificity and modality-nonspecificity by independent laboratories with the contest teams. All the teams are evaluated under the same Four Learning Conditions, e.g., the number of neurons in the engine must not exceed the same given bound. The Contest used the developmental error like the one defined here averaged over all the three contest tasks and across the three lifetimes. The developmental error ranked all the submitted contest entries and required all networks not to exceed the specified maximum number of neurons for each task so that the competition does not unfairly favor those teams that have more computational resources at their disposal but not necessarily that their methods are more superior. All the teams have a high degree of freedom to modify the learning engine and to modify the supplied motor actions on the given data set, such as generating attentive actions on the given fitting set to train invariant concepts (e.g., where and what concepts) which modifies the default training experience supplied by the AIML Contest organizers but was still based on the same supplied data set. The prudent design of the AIML contests was meant to avoid the corresponding problems in ImageNet Contests [68] and many other contests.

### D. GENISAMA Applications

GENISAMA LLC, a startup that the author created, has produced a series of real-time machine learning products, as human-wearable robots. They are the first products ever existed as APFGP robots. Hopefully, as a APFGP platform, this new kind of human-wearable robots will be useful for practitioners to produce various kinds of intelligent auto-programed software. The author predicts that such a new kind of AI systems will considerably alleviate the high brittleness of traditional AI software and traditional robot software in open and natural world.

Hopefully, future DN-driven robots will learn consciously and autonomously discover in the real world for Turing machine based general purposes, with relative infrequent interactions from humans similar to what parents do to their children and human teachers teach their students in classrooms. The experiments and competitions described here are for this grand goals but have not reached this experimental goal yet.

### V. Conclusions

We used intuitive terms but formal ways to discuss Post-Selections. A Post-Selection is like casting dice when one purchases a product. Whether the product works as the ads data have claimed depends on the outcome of casting a dice. This is an unacceptable uncertainty for many AI applications, e.g., a driverless car. Public and media have gained an impression that deep learning has approached or even “sometimes exceeded” human level performance on certain tasks. For example, the image classification errors from a static image set were compared with those of humans [68, A2, p 242]) and the work is laudable. However, this paper raises Post-Selections, which seem to question such claims since a real human does not have the luxury of Post-Selections. The author hopes that the exposure of Post-Selections is beneficial to AI credibility and the future healthy development of AI, especially with the concepts of developmental errors and the framework of ML-optimal lifetime learning for invariant concepts under the Four Learning Conditions. Some researchers have raised that it seems that those who wan a competition were those who have more computational resources and manpower at their disposal. The new developmental error metrics under the Four Learning Conditions hopefully encourages future AI competitions to compare methods under the same Four Learning Conditions. Considering DN as a much-simplified model for a biological machine, it seems not baseless to guess that each biological brain is probably ML-optimal (of course in a much richer sense) across lifetime, e.g., due to the pressure to compete at every age. The Four Learning Conditions explicitly include other factors that greatly affect machine learning performances such as learning framework (e.g., task-nonspecificity, incremental learning, the robot bodies), learning experiences and computational resources. The analysis that any “big data” sets are nonscalable does not mean that we should not create, use and share data sets. Instead, we need to pay attention to the fundamental limitations of any static data sets, regardless how large their apparent sizes are.

### REFERENCES

[1] Nick Montfort. Twisty Little Passages: An Approach to Interactive Fiction. MIT Press, Cambridge, MA, 2005.
[2] A. M. Turing. Computing machinery and intelligence. Mind, 59:433-460, October 1950.
[3] J. Weng. Symbolic models and emergent models: A review. IEEE Trans. Autonomous Mental Development, 4(1):29-53, 2012.
[4] S. Russell and P. Norvig. Artificial Intelligence: A Modern Approach. Prentice-Hall, Upper Saddle River, New Jersey, 3rd edition, 2010.
[5] M. Minsky. Logical versus analogical or symbolic versus connectionist or neat versus scruffy. AI Magazine, 12(2):34-51, 1991.
[6] D. B. Lenat, G. Miller, and T. T. Yokoi. CYC, WordNet, and EDR: Critiques and responses. Communications of the ACM, 38(11):45-48, 1995.
[7] L. Gomes. Machine-learning maestro Michael Jordan on the delusions of big data and other huge engineering efforts. IEEE Spectrum, Online article posted Oct. 20, 2014.
[8] D. E. Rumelhart, J. L. McClelland, and the PDP Research Group. Parallel Distributed Processing, volume 1. MIT Press, Cambridge, Massachusetts, 1986.
[9] J. L. McClelland, D. E. Rumelhart, and The PDP Research Group, editors. Parallel Distributed Processing, volume 2. MIT Press, Cambridge, Massachusetts, 1986.
[10] R. Krishna, Y. Zhu, O. Groth, J. Johnson, K. Hata, J. Kravitz, S. Chen, Y. Kalantidis, L. J. Li, D. A. Shamma, M. S. Ernstein, and Li Fei-Fei. Visual genome. International Journal of Computer Vision, 123(1):32-73, 2017.
[11] K. I. Funahashi. On the approximate realization of continuous mappings by neural networks. Neural Network, 2(2):183-192, March 1989.
[12] T. Poggio and F. Girosi. Networks for approximation and learning. Proceedings of The IEEE, 78(9):1481-1497, 1990.
[13] T. Kohonen. Self-Organizing Maps. Springer-Verlag, Berlin, 3rd edition, 2001.
[14] K. Fukushima. Neocognitron: A self-organizing neural network model for a mechanism of pattern recognition unaffected by shift in position. Biological Cybernetics, 36:193-202, 1980.
[15] M. Oja, S. Kaski, and T. Kohunen. Bibliography self-organizing maps (som) papers: 1998-2001 addendum. Neural Computing Surveys, 3:1-156, 2003.
[16] J. Weng, N. Ahuja, and T. S. Huang. Learning recognition and segmentation using the Cresceptron. International Journal of Computer Vision, 25(2):109-143, November 1997.
[17] K. Fukushima, S. Miyake, and T. Ito. Neocognitron: A neural network model for a mechanism of visual pattern recognition. IEEE Trans. Systems, Man and Cybernetics, 13(5):826-834, 1983.
[18] T. Serre, T. Poggio, M. Riesenhuber, L. Wolf, and S. Bileschi. High-performance vision system exploiting key features of visual cortex. U.S. Pat. No. 7,606,777B2, Sep. 1, 2006.
[19] L. Fei-Fei, R. Fergus, and Pietro Perona. One-shot learning of object categories. IEEE Trans. Pattern Analysis and Machine Intelligence, 28(4):594-611, 2006.
[20] J. Weng. Dialog initiation: Modeling amd: Closed skull or not? IEEE CIS Autonomous Mental Development Newsletter, 9(2):10-11, 2012.
[21] P. J. Werbos. The Roots of Backpropagation: From Ordered Derivatives to Neural Networks and Political Forecasting. Wiley, Chichester, 1994.
[22] Y. LeCun, L. Bottou, Y. Bengio, and P. Haffner. Gradient-based learning applied to document recognition. Proceedings of IEEE, 86(11):2278-2324, 1998.
[23] A. Krizhevsky, I. Sutskever, and G. E. Hinton. Imagenet classification with deep convolutional neural networks. In Advances in Neural Information Processing Systems, volume 25, pages 1106-1114, 2012.
[24] Y. LeCun, L. Bengio, and G. Hinton. Deep learning. Nature, 521:436-444, 2015.
[25] V. Mnih, K. Kavukcuoglu, D. Silver, A. A. Rusu, J. Veness, M. G. Bellemare, A. Graves, M. Riedmiller, A. K. Fidjeland, G. Ostrovski, S. Petersen, C. Beattie, A. Sadik, I. Antonoglou, H. King, D. Kumaran, D. Wierstra, S. Legg, and D. Hassabis. Human-level control through deep reinforcement learning. Nature, 518:529-533, 2015.
[26] D. Silver, A. Huang, C. J. Maddison, A. Guez, L. Sifre, G. van den Driessche, J. Schrittwieser, I. Antonoglou, V. Panneershelvam, M. Lanctot, S. Dieleman, D. Grewe, J. Nham, N. Kalchbrenner, I. Sutskever, T. Lillicrap, M. Leach, K. Kavukcuoglu, T. Graepel, and D. Hassabis. Mastering the game of go with deep neural networks and tree search. Nature, 529:484-489, Jan. 27, 2016.
[27] A. Graves, G. Wayne, M. Reynolds, T. Harley, I. Danihelka, A. Grabska-Barwinska, S. G. Colmenarejo, E. Grefenstette, T. Ramalho, J. Agapiou, A. P. Badia, K. M. Hermann, Y. Zwols, G. Ostrovski, A. C., H. King, C. Summerfield, P. Blunsom, K. Kavukcuoglu, and D. Hassabis. Hybrid computing using a neural network with dynamic external memory. Nature, 538:471-476, 2016.
[28] D. Silver, J. Schrittwieser, K. Simonyan, I. Antonoglou, A. Huang, A. Guez, T. Hubert, L. Baker, M. Lai, A. Bolton, Y. Chen, T. Lillicrap, F. Hui, L. Sifre, G. van den Driessche, T. Graepel, and D. Hassabis. Mastering the game of go without human knowledge. Nature, pages 354-359, 2017.
[29] S. M. McKinney, M. Sieniek, V. Godbole, J. Godwin, N. Antropova, H. Ashrafian, T. Back, M. Chesus, G. S. Corrado, A. Darzi, M. Etemadi, F. Garcia-Vicente, F. J. Gilbert, M. Halling-Brown, D. Hassabis, S. Jansen, A. Karthikesalingam, C. J. Kelly, D. King, J. R. Ledsam, D. Melnick, H. Mostofi, L. Peng, J. J. Reicher, B. Romera-Paredes, R. Sidebottom, M. Suleyman, D. Tse, K. C. Young, J. De Fauw, and S. Shetty. International evaluation of an AI system for breast cancer screening. Nature, 577:89-94, 2020.
[30] A. W. Senior, R. Evans, J. Jumper, J. Kirkpatrick, L. Sifre, T. Green, C. Qin, A. Zidek, A. W. R. Nelson, A. Bridgland, H. Penedones, S. Petersen, K. Simonyan, S. Crossan, P. Kohli, D. T. Jones, D. Silver, K. Kavukcuoglu, and D. Hassabis. Improved protein structure prediction using potentials from deep learning. Nature, 577:706-710, 2020.
[31] M. G. Bellemare, S. Candido, J. Gong P. S. Castro, M. C. Machado, S. Moitra, S. S. Ponda, and Z. Wang. Autonomous navigation of stratospheric balloons using reinforcement learning. Nature, 588(7836):77-82, 2020.
[32] A. Ecoffet, J. Huizinga, J. Lehman, K. O. Stanley, and J. Clune. First return, then explore. Nature, 590(7847):580-586, Feb. 25, 2021.
[33] V. Saggio, B. E. Asenbeck, A. Hamann, T. Stromberg, P. Schiansky, V. Dunjko, N. Friis, N. C. Harris, M. Hochberg, D. Englund, S. Wolk, H. J. Briegel, and P. Walther. Experimental quantum speed-up in reinforcement learning agents. Nature, 591(7849):229-233, Mar. 11, 2021.
[34] Francis R. Willett, Donald T. Avansino, Leigh R. Hochberg, Jaimie M. Henderson, and Krishna V. Shenoy. High-performance brain-to-text communication via handwriting. Nature, 593(7858):249-254, May 13, 2021.
[35] N. Slonim, Y. Bilu, C. Alzate, R. Bar-Haim, B. Bogin, F. Bonin, L. Choshen, E. Cohen-Karlik, L. Dankin, L. Edelstein, L. Ein-Dor, R. Friedman-Melamed, A. Gavron, A. Gera, M. Gleize, S. Gretz, D. Gutfreund, A. Halfon, D. Hershcovich, R. Hoory, Y. Hou, S. Hummel, M. Jacovi, C. Jochim, Y. Kantor, Y. Katz, D. Konopnicki, Z. Kons, L. Kotlerman, D. Krieger, D. Lahav, T. Lavee, R. Levy, N. Liberman, Y. Mass, A. Menczel, S. Mirkin, G. Moshkowich, S. Ofek-Koifman, M. Orbach, E. Rabinovich, R. Rinott, S. Shechtman, D. Sheinwald, E. Shnarch, I. Shnayderman, A. Soffer, A. Spector, B. Sznajder, A. Toledo, O. Toledo-Ronen, E. Venezian1, and R. Aharonov. An autonomous debating system. Nature, 591(7850):379-384, Mar. 18, 2021.
[36] A. Mirhoseini, A. Goldie, M. Yazgan, J. W. Jiang, E. Songhori, S. Wang, Y.-J. Lee, E. Johnson, O. Pathak, A. Nazi, J. Pak, A. Tong, K. Srinivasa, W. Hang, E. Tuncer, Q. V. Lel, J. Laudon, R. Ho, R. Carpenter, and J. Dean. A graph placement methodology for fast chip design. Nature, 594(7862):207-212, 2021.
[37] Ming Y. Lu, Tiffany Y. Chen, Drew F. K. Williamson, Melissa Zhao, Maha Shady, Jana Lipkova, and Faisal Mahmood. AI-based pathology predicts origins for cancers of unknown primary. Nature, 594(7861):106-110, 2021.
[38] S. Warnat-Herresthal, H. Schultze, K. L. Shastry, S. Manamohan, S. Mukherjee, V. Garg, R. Sarveswara, K. Handler, P. Pickkers, N. A. Aziz, S. Ktena, F. Tran, M. Bitzer, S. Ossowski, N. Casadei, C. Herr, D. Petersheim, U. Behrends, F. Kern, T. Fehlmann, P. Schommers, C. Lehmann, M. Augustin, J. Rybniker, J. Altmuller, N. Mishra, J. P. Bernardes, B. Kramer, L. Bonaguro, J. SchulteSchrepping, E. De Domenico, C. Siever, M. Kraut, M. Desai, B. Monnet, M. Saridaki, C. M. Siegel, A. Drews, M. Nuesch-Germano, H. Theis, J. Heyckendorf, S. Schreiber, S. Kim-Hellmuth, COVID-19 Aachen Study (COVAS), J. Nattermann, D. Skowasch, I. Kurth, A. Keller, R. Bals, P. Nurnberg, O. Rieb, P. Rosenstiel, M. G. Netea, F. Theis, S. Mukherjee, M. Backes, A. C. Aschenbrenner, T. Ulas, D. COVID-19 Omics Initiative (DeCOI), M. M. B. Breteler, E. J. Giamarellos-Bourboulis, M. Kox, M. Becker, S. Cheran, M. S. Woodacre, E. L. Goh, and J. L. Schultze. Swarm learning for decentralized and confidential clinical machine learning. Nature, 594(7862):265-270, 2021.
[39] J. Weng, J. McClelland, A. Pentland, O. Sporns, I. Stockman, M. Sur, and E. Thelen. Autonomous mental development by robots and animals. Science, 291(5504):599-600, 2001.
[40] James L. Mcclelland, Kim Plunkett, and Juyang Weng. Guest editorial: Convergent approaches to the understanding of autonomous mental development. IEEE Trans. on Evolutionary Computation, 11(2):133-136, 2007.
[41] J. Weng. Brain as an emergent finite automaton: A theory and three theorems. International Journal of Intelligence Science, 5(2):112-131, 2015.
[42] D. Wang, Y. Duan, and J. Weng. Motivated optimal developmental leaning for sequential tasks without using rigid time-discounts. IEEE Transactions on Neural Networks and Learning Systems, 29:164-175, 2018.
[43] J. Weng, N. Ahuja, and T. S. Huang. Cresceptron: a self-organizing neural network which grows adaptively. In Proc. Int'l Joint Conference on Neural Networks, volume 1, pages 576-581, Baltimore, Maryland, June 1992.
[44] J. Weng, N. Ahuja, and T. S. Huang. Learning recognition and segmentation of 3-D objects from 2-D images. In Proc. IEEE 4th Int'l Conf Computer Vision, pages 121-128, May 1993.
[45] J. Weng. Life is science (35): Did Turing Awards go to plagiarism? Facebook blog, Mar. 4, 2020. www.facebook.com/juyang. weng/posts/10158305658699783.
[46] J. Weng. Did Turing Awards go to plagiarism? YouTube Video, May 27, 2020. 1:05 hours, https://youtu.be/EAhkH79TKFU.
[47] J. Weng. Natural and Artificial Intelligence: Introduction to Computational Brain-Mind. BMI Press, Okemos, Michigan, 2nd edition, 2019.
[48] J. Weng and M. Luciw. Dually optimal neuronal layers: Lobe component analysis. IEEE Trans. Autonomous Mental Development, 1(1):68-85, 2009.
[49] J. Weng. Why have we passed “neural networks do not abstract well”? Natural Intelligence: the INNS Magazine, 1(1):13-22, 2011.
[50] J. Weng and M. D. Luciw. Brain-inspired concept networks: Learning concepts from cluttered scenes. IEEE Intelligent Systems Magazine, 29(6):14-22, 2014.
[51] J. Weng. Autonomous programming for general purposes: Theory. International Journal of Humanoid Robotics, 17(4):1-36, August 2020.
[52] J. Weng. Conscious intelligence requires developmental autonomous programming for general purposes. In Proc. IEEE Int. Conf on Dev. Learning and Epigenetic Robotics, pages 1-7, Valparaiso, Chile, Oct. 26-27, 2020.
[53] Z. Ji, J. Weng, and D. Prokhorov. Where-what network 1: “Where” and “What” assist each other through top-down connections. In Proc. IEEE Int'l Conference on Development and Learning, pages 61-66, Monterey, CA, Aug. 9-12, 2008.
[54] Q. Guo, X. Wu, and J. Weng. Cross-domain and within-domain synaptic maintenance for autonomous development of visual areas. In Proc. the Fifth Joint IEEE International Conference on Development and Learning and on Epigenetic Robotics, pages 1-6, Providence, RI, Aug. 13-16, 2015.
[55] C. M. Super. Environmental effects on motor development: A case of Africa infant precocity. Developmental Medicine and Child Neurology, 18:561-567, 1976.
[56] K. A. Thoroughman and J. A. Taylor. Rapid reshaping of human motor generalization. Journal of Neuroscience, 25(39):8948-8953, 2005.
[57] G. Rizzotti, L. Riggio, I. Dascola, and C. Umilta. Reorienting attention across the horizontal and vertical meridians: evidence in favor of a premotor theory of attention. Neuropsychologia, 25:31-40, 1987.
[58] T. Moore, K. M. Armstrong, and M. Fallah. Visuomotor origins of covert spatial attention. Neuron, 40:671-683, 2003.
[59] J. M. Iverson. Developing language in a developing body: the relationship between motor development and language development. Journal of child language, 37(2):229-261, 2010.
[60] J. Weng and M. Luciw. Brain-like emergent spatial processing. IEEE Trans. Autonomous Mental Development, 4(2):161-185, 2012.
[61] J. Weng, M. Luciw, and Q. Zhang. Brain-like temporal processing: Emergent open states. IEEE Trans. Autonomous Mental Development, 5(2):89-116, 2013.
[62] J. Weng, Zejia Zheng, Xiang Wu, and Juan Castro-Garcia. Auto-programming for general purposes: Theory and experiments. In Proc. International Joint Conference on Neural Networks, pages 1-8, Glasgow, UK, Jul. 19-24, 2020.
[63] A. Roy. Connectionism, controllers, and a brain theory. IEEE Trans. on System, Man, and Cybernetics—Part A; Systems and Humans, 38(6):1434-1441, November 2008.
[64] D. J. Felleman and D. C. Van Essen. Distributed hierarchical processing in the primate cerebral cortex. Cerebral Cortex, 1:1-47, 1991.
[65] D. Silver, T. Hubert, J. Schrittwieser, I. Antonoglou, M. Lai, A. Guez, M. Lanctot, L. Sifre, D. Kumaran, T. Graepel, T. Lillicrap, K. Simonyan, and D. Hassabis. A general reinforcement learning algorithm that masters chess, shogi, and go through self-play. Science, pages 1140-1144, 2018.
[66] M. Moravcik, M. Schmid, N. Burch, V. Lisy, D. Morrill, N. Bard, T. Davis, K. Waugh, M. Johanson, and M. Bowling. Deepstack: Expert-level artificial intelligence in heads-up no-limit poker. Science, 356:508-513, 2017.
[67] J. Schrittwieser, I. Antonoglou, T. Hubert, K. Simonyan, L. Sifre, S. Schmitt, A. Guez, E. Lockhart, D. Hassabis, T. Graepel, T. Lillicrap, and D. Silver. Mastering Atari, Go, chess and shogi by planning with a learned model. Science, 588(7839):604-609, 2020.
[68] O. Russakovsky, J. Deng, H. Su, J. Krause, S. Satheesh, S. Ma, Z. Huang, A. Karpathy, A. Khosla, M. Bernstein, A. C. Berg, and L. Fei-Fei. ImageNet large scale visual recognition challenge. International Journal of Computer Vision, 115:211-252, 2015.
[69] A. Krizhevsky, I. Sutskever, and G. E. Hinton. Imagenet classification with deep convolutional neural networks. Communications of the ACM, 60(6):84-90, 2017.
[70] Q. Gao, G. A. Ascoli, and L. Zhao. BEAN: Interpretable and efficient learning with biologically-enhanced artificial neuronal assembly regularization. Front. Neurorobot, pages 1-13, 2021. See FIG. 7.
[71] Z. Zheng and J. Weng. Mobile device based outdoor navigation with on-line learning neural network: a comparison with convolutional neural network. In Proc. 7th Workshop on Computer Vision in Vehicle Technology (CVVT 2016) at CVPR 2016, pages 11-18, Las Vegas, June 269 2016.
[72] H. Lee, R. Grosse, R. Ranganath, and A. Y. Ng. Convolutional deep belief networks for scalable unsupervised learning of hierarchical representations. In Proc. 26th Int'l Conf on Machine Learning, pages 609-616, Montreal, Canada, Jun. 14-18, 2009.
[73] J. Weng, Z. Zheng, X. Wu, J. Castro-Garcia, S. Zhu, Q. Guo, and X. Wu. Emergent Turing machines and operating systems for brain-like auto-programming for general purposes. In Proc. AAAI 2018 Fall Symposium: Gathering for AI and Natural Systems, pages 1-7, Arlington, Virginia, Oct. 18-20, 2018.
[74] D. H. Ballard and C. M. Brown. Computer Vision. Prentice-Hall, New Jersey, 1982.
[75] L. Shapiro and G. Stockman. Computer Vision. Addison-Wesley, New York, 2001.
[76] A. Karpathy, G. Toderici, S. Shetty, T. Leung, R. Sukthankar, and Li Fei-Fei. Large-scale video classification with convolutional neural networks. In Proc. Computer Vision and Pattern Recognition, pages 1-8, Columbus, Ohio, Jun. 24-27, 2014.
[77] D. J. Wood, J. S. Bruner, and G. Ross. The role of tutoring in problem-solving. Journal of Child Psychology and Psychiatry, pages 89-100, 1976.
[78] S. Burr. Active learning literature survey. Data Mining and Knowledge Discovery, 2(2):121-167, 1998.
[79] A. K. Jain and R. C. Dubes. Algorithms for Clustering Data. Prentice-Hall, New Jersey, 1988.
[80] Y. Wang, X. Wu, and J. Weng. Synapse maintenance in the where-what network. In Proc. Int'l Joint Conference on Neural Networks, pages 2823-2829, San Jose, CA, Jul. 31-Aug. 5, 2011.
[81] Q. Guo, X. Wu, and J. Weng. WWN-9: Cross-domain synaptic maintenance and its application to object groups recognition. In Proc. Int'l Joint Conference on Neural Networks, pages 1-8, Beijing, China, Jul. 6-11, 2014.
[82] J. Weng. Life is science (36): Did Turing Awards go to fraud? Facebook blog, Mar. 8, 2020. www.facebook.com/juyang.weng/posts/10158319020739783.
[83] J. Weng. Did Turing Awards go to fraud? YouTube Video, Jun. 4, 2020. 1:04 hours, https://youtu.be/Rz6CFlKrx2k.
[84] T. Serre, L. Wolf, S. Bileschi, M. Riesenhuber, and T. Poggio. Robust object recognition with cortex-like mechanisms. IEEE Trans. Pattern Analysis and Machine Intelligence, 29(3):411-426, 2007.
[85] Y. Bengio, Y. LeCun, and G. Hinton. Deep learning for AI. Communications of ACM, 64(7):58-65, 2021.
[86] P. Sermanet, K. Kavukcuoglu, S. Chintala, and Y. LeCun. No more pesky learning rates. In Proc. International Conference on Machine learning, pages 343-351, Atlanta, GA, Jun. 16-21, 2013.
[87] Y. N. Dauphin, R. Pascanu, C. Gulcehre, K. Cho, S. Ganguli, and Y. Bengio. Identifying and attacking the saddle point problem in high-dimensional non-convex optimization. In Advances in Neural Information Processing Systems, pages 2933-2941, Montreal, Canada, 2014. Curran Associates, Inc.
[88] N. Srivastava, G. E¿ Hinton, K. Krizhevsky, I. Sutskever, and R. Salakhutdinov. Dropout: A simple way to prevent neural networks from overtting. Journal of Machine Learning Research, 15(1):1929-1958, 2014.
[89] T. Poggio. Theoretical issues in deep networks. Proceedings of the National Academy of Sciences, 117(48):30039-30045, 2020.
[90] A. Choromanska, M. Henaff, M. Mathieu, G. B. Arous, and Y. LeCun. The loss surfaces of multilayer networks. In Proc. Machine Learning Research, volume 38, pages 192-204, 2015.
[91] K. Kawaguchi. Deep learning without poor local minima. Technical Report arXiv:1605.07110, MIT-CSAIL-TR-2016-005, Cambridge, MA, May 23, 2016.
[92] J. Weng, Z. Zheng, and X. Wu. Developmental Network Two, its optimality, and emergent Turing machines. U.S. patent application Ser. No. 16/265,212, Feb. 1, 2019. Approval pending.
[93] J. A. Knoll, V. N. Hoang, J. Honer, S. Church, T. H. Tran, and J. Weng. Optimal developmental learning for multisensory and multi-teaching modalities. In Proc. IEEE International Conference on Development and Learning, pages 1-6, Beijing, China, Oct. 23-26, 2021.
[94] J. Weng. A unified hierarchy for AI and natural intelligence through auto-programming for general purposes. Journal of Cognitive Science, 21:53-102, 2020.
[95] L. R. Rabiner. A tutorial on hidden Markov models and selected applications in speech recognition. Proceedings of IEEE, 77(2):257-286, 1989.
[96] Z. Zheng, X. Wu, and J. Weng. Emergent neural turing machine and its visual navigation. Neural Networks, 110:116-130, 2019.
[97] X. Wu and J. Weng. Muscle vectors as temporally “Dense Labels”. In Proc. International Joint Conference on Neural Networks, pages 1-8, Glasgow, UK, Jul. 19-24, 2020.
[98] J. Castro-Garcia and J. Weng. Emergent multilingual language acquisition using developmental networks. In Proc. International Joint Conf Neural Networks, pages 1-8, Budapest, Hungary, Jul. 14-19, 2019. IEEE Press.
[99] X. Wu and J. Weng. On machine thinking. In Proc. International Joint Conf Neural Networks, pages 1-8, Shenzhen, China, Jul. 18-22, 2021. IEEE Press.

What is claimed is:

1) A nonlinear agent machine in which the relations among observations, internal representations and motor representations are nonlinear (not related by multiplication of a constant matrix and an addition of a constant vector), including neural networks but also other kinds of nonlinear agents, each of which having a single or multiple sensors and a single or multiple effectors
(a) that has a set of parameters randomly initialized,
(b) that learns incrementally by updating a set of parameters at each indexed time and
(c) that always develops normally through indexed times without conducting a post-selection from multiple trained agents.

2) A computing processor of claim 1) is a Central Processing Unit (CPU), a Graphic Processing Unit (GPU), a Field Programmable Gate Array (FPGA), or an Application Specific Integrated Circuit (ASIC) System on Chip (SOC).

3) The agent of claim 1) that maps from a space of input symbols to a space of class symbols.

4) The agent of claim 1) that maps from a 2-tuple joint space of input symbols and context symbols to a space of context symbols wherein the context symbols may include actions.

5) The agent of claim 1) that maps from a 2-tuple joint space of a vector sensory inputs and a vector context space to a space of the vector context space wherein the context space may include actions.

6) The agent of claim 1) that maps from a 3-tuple joint space of a sensory space, a hidden space, and a context space to a 2-tuple joint space of the hidden space and the context space wherein the context space may include actions.

7) The agent of claim 1) wherein the system parameters have two parts, hyper-parameters that are fixed for the agent and weights that are time-varying for the agent.

8) The agent of claim 1) whose parameters at a time index are updated, in a closed form or iteratively, as those that maximize the probability using the parameters and observations at a previous time index.

9) The agent of claim 7) wherein the sensitivity of system hyper-parameters is measured in terms of a standard deviation of each hyper-parameter.

10) The agent of claim 7) wherein the sensitivity of weights is cross-validated by an average of agent performances wherein each agent uses a different set of random initial weights.

11) The agent of claim 7) wherein the sensitivity of weights is cross-validated by their distributions across different agent performances wherein each agent uses a different set of random initial weights.

12) The agent of claim 1) wherein the performance is compared based on four conditions, (1) a body including sensors and effectors, (2) a set of restrictions of learning framework, including whether task-specific or task-nonspecific, batch learning or incremental learning, (3) a training experience and (4) a limited amount of computational resources including the number of hidden neurons.

13) The agent of claim 1) which does not use any statically collected data set, instead, use data sensed from an environment and generated by the agent on the fly.

14) The agent of claim 1) whose fitting errors, validation errors and test errors at an indexed time are recorded across lifetime so that characteristics of their distributions are reported as trajectories of lifetime learning performance.

15) The agent of claim 1) which has a developmental procedure containing a prenatal development stage and a postnatal development stage.

16) The agent of claim 1) where each neuron has its own competition zone.

17) The agent of claim 1) where neurons in each area share the same competition zone.

18) A method to compare an AI method with a simple learner that learns by storing all training data as a batch and uses a threshold to decide whether an output from an input is that of a nearest neighbor of the input or a randomly guessed output.

19) A post-selection of the simple learner in claim 18) satisfies any validation error rates and any test error rates including zeros, if its time of post-selections and its storage space are unbounded.

20) A method for randomly initializing weights of neural networks in which each hidden neuron has only a small probability to fire, given an input, among all neurons that share the same receptive field with the neuron.
